(19) United States
(12) Patent Application Publication
(10) Pub. No.: US 2026/0162043 A1
(43) Pub. Date: Jun. 11, 2026

(54) METHODS AND SYSTEMS FOR GENERATING A CALIBRATED PREDICTION FOR AN EVENT

(71) Applicant: MASTERCARD INTERNATIONAL INCORPORATED, Purchase, NY (US)

(72) Inventors: Soumyadeep GHOSH, Gurgaon (IN); Awanish KUMAR, Lucknow (IN); Arun KANTHALI, Dewas (IN)

(73) Assignee: MASTERCARD INTERNATIONAL INCORPORATED, Purchase, NY (US)

(21) Appl. No.: 18/970,495

(22) Filed: Dec. 5, 2024

(51) Int. Cl. G06Q 10/0637; G06N 20/00

(52) U.S. Cl. CPC G06Q 10/06375; G06N 20/00

(57) ABSTRACT

Methods and systems for generating a prediction for an event are disclosed. Method performed by a server system includes accessing a feature set corresponding to each data sample in an input dataset. Method further includes generating, by a set of decision trees associated with the server system, an intermediate prediction for the event based on applying the feature set on the set of decision trees. Method includes identifying an activated leaf node from each decision tree based on the intermediate prediction. Method includes generating a tree-based encoding indicating an encoded representation of the set of decision trees for each data sample based on an encoding type and the activated leaf node from each decision tree. Method includes generating the prediction. Herein, the prediction is calibrated by a calibration model associated with the server system based on the tree-based encoding for each data sample.

### TECHNICAL FIELD

The present disclosure relates to artificial intelligence-based processing systems and, more particularly, to electronic methods and complex processing systems for generating a calibrated prediction for an event such as a real-time application.

### BACKGROUND

In recent times, with the advancement of technology, Artificial Intelligence (AI) and/or Machine Learning (ML) models have been adopted across various real-time applications. These applications include product recommendation, identifying spam, customer service, demand forecast, prediction systems internal to organizations, etc. These AI or ML models improve such applications by providing hidden insights while expediting previous manual tasks. Probabilistic ML models generally provide predictions in the form of numerical values between 0 and 1 along with providing binary predictions (i.e., values 1 or 0 assigned to a class indicating whether a particular data sample belongs to the class or not). Values between 0 and 1 are referred to as probability values indicating the likelihood that a particular data sample belongs to a particular class.

For example, when a model is trained for fraud detection on financial data, the binary prediction of ‘1’ for a subset of transactions can indicate that the said transactions are fraudulent, whereas ‘0’ can indicate that the said transactions are non-fraudulent. In an instance, if the probability value for a transaction is 0.7, then it indicates that there exists a 70% likelihood as per the model that the said transaction is fraudulent and a 30% likelihood that the said transaction is non-fraudulent. In other words, for the said transaction, the model has 70% confidence regarding the transaction being a fraudulent transaction.

Thus, it is to be noted that the probability values generated by the ML models also indicate the confidence of the ML model in performing the classification task. More specifically, data samples that are associated with probability values close to the boundary (i.e., threshold (e.g., 0.5)) are samples that are classified with less confidence. Such samples are most likely wrongly classified which can be determined based on the accuracy of the model. Such results require calibration which refers to a process of making meaningful minor changes to the model's predictions to improve both accuracy and confidence in those predictions.

Conventionally, several approaches have been implemented for calibrating Neural Network (NN)-based models. Some of the approaches utilize techniques, such as label smoothing, regularization, focal loss, and so on that help train models that are calibrated better. Some other approaches utilize post-processing techniques, such as Platt scaling, logistic regression, isotonic regression, histogram binning, or the like which work on NN-based models. However, for large datasets that are generally part of real-world applications, ML models, such as tree-based models are preferred. The above-mentioned approaches are not applicable to tree-based models as the representations associated with tree-based models are more complex and difficult to align with the above-mentioned processing techniques.

Thus, there exists a need for technical solutions, such as improved methods and systems for generating a calibrated prediction for an event while overcoming the aforementioned technical drawbacks.

### SUMMARY

Various embodiments of the present disclosure provide methods and systems for generating a prediction for an event.

In an embodiment, a computer-implemented method for generating a prediction for an event is disclosed. The computer-implemented method performed by a server system includes accessing a feature set corresponding to each data sample in an input dataset from a database associated with the server system. The computer-implemented method further includes generating, by a set of decision trees associated with the server system, an intermediate prediction for the event based, at least in part, on applying the feature set of each data sample on the set of decision trees. Each decision tree includes a plurality of nodes. Further, the computer-implemented method includes identifying an activated leaf node from each decision tree based, at least in part, on the intermediate prediction. The activated leaf node indicating a leaf node of one or more leaf nodes of the corresponding decision tree contributing to the intermediate prediction. Furthermore, the computer-implemented method includes generating a tree-based encoding indicating an encoded representation of the set of decision trees for each data sample based, at least in part, on an encoding type and the activated leaf node from each decision tree. Moreover, the computer-implemented method includes generating the prediction for the event. Herein, the prediction is calibrated by a calibration model associated with the server system based, at least in part, on the tree-based encoding for each data sample.

In another embodiment, a server system is disclosed. The server system includes a communication interface and a memory including executable instructions. The server system also includes a processor communicably coupled to the memory. The processor is configured to execute the instructions to cause the server system, at least in part, to access a feature set corresponding to each data sample in an input dataset from a database associated with the server system. The server system is further caused to generate, by a set of decision trees associated with the server system, an intermediate prediction for the event based, at least in part, on applying the feature set of each data sample on the set of decision trees. Each decision tree includes a plurality of nodes. Further, the server system is caused to identify an activated leaf node from each decision tree based, at least in part, on the intermediate prediction. The activated leaf node indicating a leaf node of one or more leaf nodes of the corresponding decision tree contributing to the intermediate prediction. Furthermore, the server system is caused to generate a tree-based encoding indicating an encoded representation of the set of decision trees for each data sample based, at least in part, on an encoding type and the activated leaf node from each decision tree. Moreover, the server system is caused to generate the prediction for the event. Herein, the prediction is calibrated by a calibration model associated with the server system based, at least in part, on the tree-based encoding for each data sample.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a feature set corresponding to each data sample in an input dataset from a database associated with the server system. The method further includes generating, by a set of decision trees associated with the server system, an intermediate prediction for the event based, at least in part, on applying the feature set of each data sample on the set of decision trees. Each decision tree includes a plurality of nodes. Further, the method includes identifying an activated leaf node from each decision tree based, at least in part, on the intermediate prediction. The activated leaf node indicating a leaf node of one or more leaf nodes of the corresponding decision tree contributing to the intermediate prediction. Furthermore, the method includes generating a tree-based encoding indicating an encoded representation of the set of decision trees for each data sample based, at least in part, on an encoding type and the activated leaf node from each decision tree. Moreover, the method includes generating the prediction for the event. Herein, the prediction is calibrated by a calibration model associated with the server system based, at least in part, on the tree-based encoding for each data sample.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a block diagram depicting a calibration process applied on a Neural Network (NN)-based model, in accordance with an embodiment of the present disclosure;

FIG. 4 illustrates a graphical representation of a reliability diagram for an example scenario, in accordance with an embodiment of the present disclosure;

FIG. 5A illustrates a block diagram depicting a calibration process applied on a set of decision trees, in accordance with an embodiment of the present disclosure;

FIG. 5B illustrates a schematic representation of a process of generating a tree-based encoding for a data sample, in accordance with an embodiment of the present disclosure;

FIG. 5C illustrates a schematic representation of a process of generating a tree-based encoding for the data sample, in accordance with another embodiment of the present disclosure;

FIG. 6 illustrates a graphical representation of reliability diagrams for different calibration processes implemented as an experimental setup, in accordance with an embodiment of the present disclosure;

FIG. 7 illustrates a graphical representation depicting variation of a calibration error with a regularization parameter for L1 regularization and L2 regularization, in accordance with an embodiment of the present disclosure;

FIG. 8 illustrates a graphical representation depicting an impact on the calibration error and a model performance parameter for different calibration processes and different size for a validation dataset, in accordance with an embodiment of the present disclosure;

FIG. 9 illustrates a graphical representation for t-distributed stochastic neighbor embedding (T-SNE) plots for different datasets and encoding types, in accordance with an embodiment of the present disclosure;

FIG. 10 illustrates a graphical representation for weight histograms of a calibration model for different experimental setups, in accordance with an embodiment of the present disclosure;

FIG. 11 illustrates a schematic representation of another environment related to at least some example embodiments of the present disclosure;

FIG. 12 illustrates a schematic representation of yet another environment related to at least some example embodiments of the present disclosure; and

FIG. 13 illustrates a flow diagram depicting a method for generating a prediction for an event, in accordance with an embodiment of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the term “calibration” used throughout the description generally refers to a process of making meaningful minor changes to the model's predictions to improve confidence in those predictions. It is noted that the improvement in confidence ultimately improves the accuracy of the model.

The term “confidence” used throughout the description, in Machine Learning (ML), generally refers to an amount or a percentage of certainty with which a data sample is classified in a particular class. The confidence values are reflected by probability values predicted by the ML model. The higher the probability values, the higher the confidence with which the ML model makes the prediction. For example, if the probability value for a data sample is 0.9 for a first class, then the model is 90% confident that the data sample belongs to the first class.

Further, the term “accuracy” used throughout the description, in ML, generally refers to a metric that measures how often the ML model makes correct predictions. In other words, accuracy is the percentage of correct predictions the ML model makes. It is calculated by dividing the number of correct predictions by the total number of predictions.

Furthermore, the terms “Neural Network-based model” and “NN-based model” are used interchangeably throughout the description and refer to an ML model that mimics the human brain. It consists of layers of interconnected nodes (or neurons) that process input data through a series of transformations to make predictions. Each neuron receives input, applies a weighted sum, passes it through an activation function, and forwards the result to the next layer. NN-based models can be used in complex tasks, such as image recognition, natural language processing, time series forecasting, etc.

The term “decision tree” used throughout the description, generally refers to a type of ML model that uses a decision tree structure to make decisions. It splits the data into subsets based on feature values, creating a tree where nodes represent features, branches represent decision rules based on the feature values, and leaf nodes represent the final predicted outcome (i.e., either a class label or a numerical value). Examples of the ML models that use decision trees include a single decision tree model, Random forests, Gradient Boosted trees, etc.

### Overview

Various embodiments of the present disclosure provide methods, systems electronic devices, and computer program products for generating a calibrated prediction for an event. In one embodiment, the present disclosure describes a server system that is configured to access an input dataset from a database associated with the server system. The input dataset may include a plurality of data samples associated with a plurality of users. The server system may generate a feature set for each data sample of the plurality of data samples based, at least in part, on the input dataset. Further, the server system may store the feature set for each data sample in the database.

In a specific embodiment, the server system is configured to access the feature set corresponding to each data sample in the input dataset from the database. Further, the server system may generate an intermediate prediction for the event based, at least in part, on applying the feature set of each data sample on a set of decision trees associated with the server system. Each decision tree may include a plurality of nodes. Furthermore, the server system may identify an activated leaf node from each decision tree based, at least in part, on the intermediate prediction. The activated leaf node indicating a leaf node of one or more leaf nodes of the corresponding decision tree contributing to the intermediate prediction. Moreover, the server system may generate a tree-based encoding indicating an encoded representation of the set of decision trees for each data sample based, at least in part, on an encoding type and the activated leaf node from each decision tree.

More specifically, in one embodiment, the server system may generate a set of leaf-based encodings for the set of decision trees based, at least in part, on the encoding type and the one or more leaf nodes in each decision tree. Each leaf-based encoding may indicate a leaf-level encoded representation of each decision tree for each data sample. Further, the server system may concatenate the set of leaf-based encodings to obtain a tree-based encoding for each data sample.

In a specific embodiment, in response to determining that the encoding type is a position-based encoding, the server system may generate a position-type leaf-based encoding for the decision tree. Herein, the position-type leaf-based encoding is the leaf-based encoding. More specifically, the server system may assign a first label to the activated leaf node and a second label to each of remaining leaf nodes of the one or more leaf nodes of the decision tree. Then, the server system may concatenate the first label and the second label of each of the remaining leaf nodes based, at least on a position of each of the one or more leaf nodes in the decision tree to obtain the position-type leaf-based encoding of the decision tree.

In another specific embodiment, in response to determining that the encoding type is a weight-based encoding, the server system may generate a weight-type leaf-based encoding for the decision tree. Herein, the weight-type leaf-based encoding is the leaf-based encoding. Morre specifically, the server system may extract a weight parameter associated with the activated leaf node from the decision tree. Then, the server system may assign the extracted weight parameter to the leaf-based encoding of the decision tree to obtain the weight type leaf-based encoding.

Then, the server system may generate the prediction for the event. In a non-limiting implementation, the prediction is calibrated by a calibration model associated with the server system based, at least in part, on the tree-based encoding for each data sample. Before using the calibration model, it may have to be trained. Thus, in one embodiment, the server system may access a training feature set for each training data sample of a training dataset from the database. Herein, the training feature set may include ground truth labels. Further, the server system may generate a plurality of training tree-based encodings for a plurality of training data samples, respectively of the training dataset. Furthermore, the server system may train the calibration model to generate the prediction for the event that is calibrated. Herein, training the calibration model may include performing iteratively, a set of operations until convergence criteria are met. The set of operations may include: (i) initializing the calibration model based, at least in part, on one or more calibration model parameters; (ii) generating, by the calibration model, a calibrated predicted probability score for each training data sample based, at least in part, on the plurality of training tree-based encodings and the one or more calibration model parameters, the calibrated predicted probability score indicating a likelihood of an occurrence of the event; (iii) generating, by the calibration model, the prediction for the event based, at least in part, on the calibrated predicted probability score and an event threshold, the prediction comprising a label associated with the event; (iv) computing, by the calibration model, a regularized loss for each training data sample based, at least in part, on the calibrated predicted probability score, the ground truth labels, and a regularized loss function; and (v) optimizing the one or more calibration model parameters based, at least in part, on the regularized loss.

In some embodiments, the server system may extract an intermediate predicted probability score associated with the intermediate prediction for each data sample from the set of decision trees. Herein, the intermediate predicted probability score may indicate a likelihood of the event to take place. Further, the server system may extract a predicted probability score associated with the prediction for each data sample from the calibration model. Herein, the predicted probability score may indicate a calibrated likelihood of the event to take place. Furthermore, the server system may access one or more actual behavior parameters related to the event from the database. The server system may further compute a first calibration error for each data sample based, at least in part, on the intermediate predicted probability score for each data sample and the one or more actual behavior parameters. The server system may also compute a second calibration error for each data sample based, at least in part, on the predicted probability score for each data sample and the one or more actual behavior parameters. The server system may compute an improvisation factor for each data sample based, at least in part, on the first calibration error and the second calibration error. Herein, the improvisation factor may indicate an extent of a positive impact on calibration of the intermediate prediction.

Various embodiments of the present disclosure offer multiple advantages and technical effects. For instance, the present disclosure aims to solve the technical problem of obtaining representations from a set of decision trees that are simple and can align with conventional techniques used for the calibration of predicted probabilities obtained from the set of decision trees. These embodiments enable calibration of the predictions generated by the decision trees during post-processing, thereby improving the predictions without retraining the models. In particular, the proposed approach generates an encoding representing the set of decision trees, such that this encoding can be further utilized to train a calibration model for generating calibrated predicted probabilities. As a result, highly accurate predictions may be obtained from the calibrated predicted probabilities. Also, the proposed approach is a post-processing technique that requires less processing power and resources to calibrate the predicted probabilities of a tree-based model. In addition, the calibration model is regularized for adjusting the length of the input dataset and weights associated with the data samples, saving further processing power and resources.

For instance, for forecasting the weather, an organization may utilize a set of decision trees to process a tabular dataset indicating weather conditions of the past few days to predict whether it will rain on a specific day or not. Suppose the decision trees generate a prediction that it will rain on the said day with a predicted probability of 0.6. Further, the decision trees (representing a model) may generate a probability of 0.6 for 10 consecutive days. Now, if the model has confidence that at least 60% of its predictions are correct, then for at least 6 days of the 10 days, there will be a 60% chance (due to the predicted probability of 0.6) that it will rain. As may be noted, there may be at max 4 days where the predicted probability by the model may be incorrect. Since, the overall probability, i.e., 60% is close to a 50% chance of there not being any rain, therefore the likelihood of the prediction being incorrect is high. If the prediction made based on these predicted probabilities has a high chance of being incorrect, then people relying on these predictions may unnecessarily carry an umbrella with them. As a result, trust in such a weather forecasting application may be lost, and it will be difficult for people to decide whether to carry an umbrella or not while going outdoors. To address this issue, the predicted probabilities from the model can be calibrated using the various approaches described herein. More specifically, to obtain calibrated predictions, a unique encoding is generated from at least one parameter associated with leaf nodes of the set of decision trees. This encoding is then provided as an input to a calibration model to generate the calibrated predicted probabilities for the event regarding whether it will rain on the said day or not. Upon calibration, the calibrated predicted probability generated for the people can be a value generated with improved confidence by the calibration model, such as 0.9. This value indicates that 9 days out of 10 days it can probably rain. It is to be noted that these results are accurate as these are obtained upon calibration. As accurate results are obtained, the people who rely on such applications can leave their houses or offices without any fear of getting wet in the rain.

Also, upon calibration, the overall probability or the certainty of the model regarding whether it will rain or not may be increased by an improvisation factor. For example, the predicted probability associated with each day may be altered after the calibration process. For instance, a predicted probability for a specific day may change from 0.6 to 0.9, while for another day it may change from 0.6 to 0.4. As may be understood, once the results of the model are calibrated, the predicted probability may represent the confidence of the model in some instances. In other words, calibrating the results of the model solidifies the confidence of the model as well.

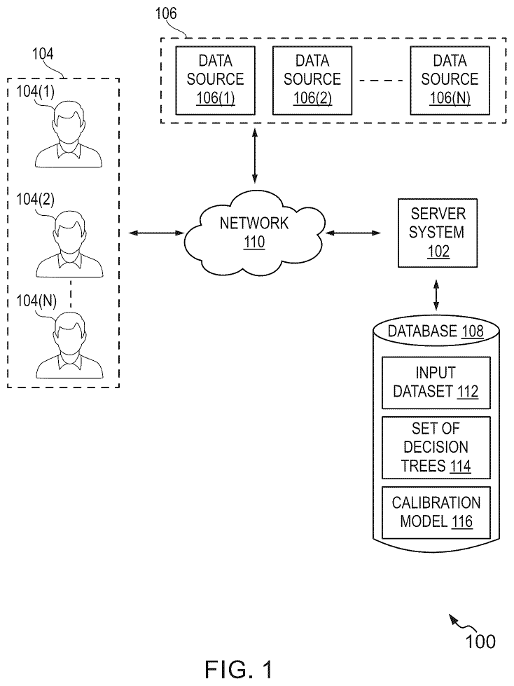

Various example embodiments of the present disclosure are described hereinafter with reference to FIG. 1 to FIG. 13.

FIG. 1 illustrates a schematic representation of an environment 100 related to at least some example embodiments of the present disclosure. Although the environment 100 is presented in one arrangement, other embodiments may include the parts of the environment 100 (or other parts) arranged otherwise depending on, for example, generating an intermediate prediction for an event, generating a tree-based encoding for a data sample, generating a prediction for the event that is calibrated based on the tree-based encoding, and the like.

The environment 100 generally includes a plurality of entities, such as a server system 102, a plurality of users 104(1), 104(2), . . . 104(N) (collectively referred to hereinafter as a ‘plurality of users 104’ or simply, ‘users 104’), a plurality of data sources 106(1), 106(2), . . . 106(N) (collectively referred to hereinafter as a ‘plurality of data sources 106’ or simply, ‘data sources 106’), a database 108, each coupled to, and in communication with (and/or with access to) a network 110. Herein, it may be noted that ‘N’ is a non-zero natural number and may be different for each distinct entity.

As may be understood, despite having impressive performance in generating predictions, the Artificial Intelligence (AI) or Machine Learning (ML) models (otherwise, also referred to as ML model(s), model(s), or AI model(s)) are associated with a problem of being poorly calibrated. It is to be noted that these models are judged based on their classification performance, however, confidence of the ML model in the assignment of the class to each data sample is an important factor of the ML model. The confidence of the ML model plays a crucial role in risk-sensitive downstream applications to take a decision. Examples of the downstream applications can include, but are not limited to, weather forecasting, fraud detection, product recommendation, or the like.

More specifically, in an instance, a weather forecasting application that predicts a 90% probability for rain for a period of 10 days, indicates that, if the ML model assigns this confidence, then 9 days out of 10 days it should rain. Based on this prediction, people going out may or may not carry an umbrella with them. A general assumption is that, if the probability is a very high value, then it will rain. However, if the ML model used by the weather forecasting application to generate such predictions is not well calibrated, then it may happen that it will rain frequently even if the probability score was predicted to be a lower value and vice versa. In such scenarios, the weather forecasting application will not serve its purpose, as the downstream decision of people using the application can be incorrect more often, even if the accuracy of the prediction may be still high.

In another instance, a fraud detection model used by a payment network assigns a score to every transaction indicating the probability that the transaction is fraudulent. If the probability score is high, then it will be declined by the payment network, otherwise, it will be allowed. Thus, it may be understood that the confidence reflected in the probability score generated by the ML model is an important score to generate accurate predictions. If such scores are not calibrated, then there is a high risk of obtaining incorrect results in the downstream tasks. As a result, the individuals, solely relying on the predictions of such models may face severe consequences, such as unexpectedly getting wet in the rain, a payment network allowing fraudulent transactions to process causing loss to various parties in the payment network, wrong product recommendation to a client, etc.

As described earlier, several approaches have been implemented, conventionally, for calibrating ML models such as Neural Network (NN)-based models. Some approaches utilize techniques during a training phase of the NN-based models. Some other approaches utilize post-processing techniques. However, the same techniques may not be applicable to the set of decision trees that are preferred in real-world applications for handling large input datasets. The set of decisions may include at least one decision tree or an ensemble of decision trees. Representations associated with the set of decision trees are more complex and difficult to align with conventional techniques.

Therefore, the above-mentioned technical problems, among other problems, are addressed by one or more embodiments implemented by the server system 102 and the methods thereof provided in the present disclosure. It should be noted that the server system 102 is targeted to implement a post-processing approach, eliminating re-training of the ML model to generate calibrated predictions. The server system 102 is also targeted to generate an encoding that represents predictions from a set of decision trees on which the post-processing approach can be applied. Further, the server system is targeted to calibrate predicted probabilities obtained from the set of decision trees.

In one embodiment, the server system 102 is used by a managing entity to train the ML model such as the set of decision trees and use it for generating predictions related to a downstream task. In a non-limiting implementation, the managing entity may be any individual, representative of a person, an institution, an organization, a corporate entity, a non-profit organization, a financial institution, a bank, medical facilities (e.g., hospitals, laboratories, etc.), educational institutions, government agencies, telecom industries, weather forecast agency, or the like. In an example, the managing entity may be an administrator of the server system 102.

Examples of the downstream task include, but are not limited to, weather forecasting, speech recognition, image classification, email spam detection, performing medical diagnosis, fraud detection, risk management, charge-back decision-making systems, payment authorization systems, data analytics, credit card scoring systems, cross-border transaction management systems, consumer segmenting, or the like.

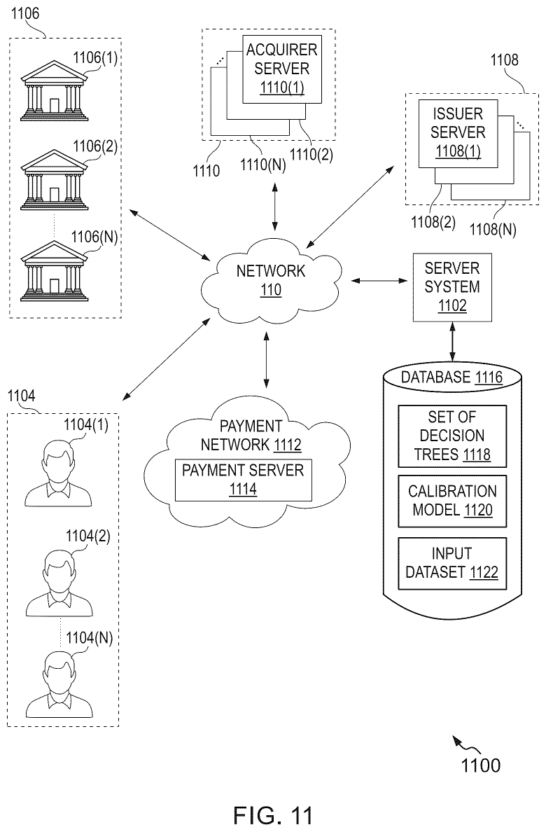

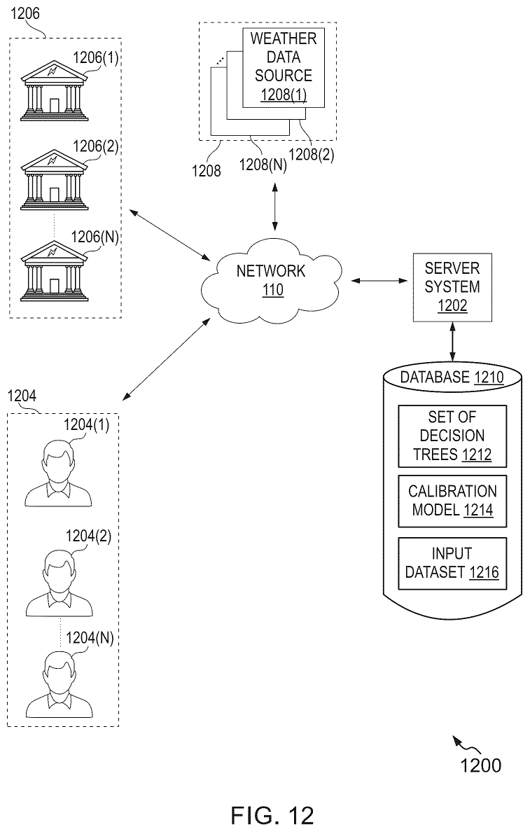

In a specific embodiment, the users (e.g., users 104) correspond to individuals whose data is used for training the models. For instance, the users 104 may be patients who are undergoing treatment for certain diseases. Data generated corresponding to such patients can be used to learn and understand the experience of the patients at a particular clinical center. Thus, such data is used to train AI or ML models to identify diseases and diagnoses. For example, classifying different diseases, such as cancer using images, predicting the progression of pre-diabetes, predicting response to depression treatment, etc. In another instance of a weather forecasting application (as shown in FIG. 12), the users 104 may correspond to individuals that provide information, such as location, date and time, preferences, alerts, activities, and the like. The information provided by such individuals can be used to generate predictions related to weather that are more personalized and actionable. For example, preferences influence how the weather forecast data is presented to the user (e.g., the user 104(1)), while activity details can enable the application to highlight relevant weather conditions (e.g., rain or wind for outdoor plans) for the user 104(1). In yet another instance of a payment industry (as shown in FIG. 11), the users 104 may be cardholders, account holders, merchants, consumers, issuers, acquirers, banks, third-party users, financial institutions, or the like. Data related to such individuals include historical financial transaction-related data, income-related data, expenditure-related data, and the like. Such data can be used to train AI or ML models to predict the income of an individual, predict financial frauds and risks, perform payment authorization operations, and the like.

In some embodiments, the users 104 may use their corresponding electronic devices (not shown in figures) to access a mobile application or a website associated with the issuing bank, or any third-party payment application to perform a payment transaction. In various non-limiting examples, the electronic devices may refer to any electronic devices, such as, but not limited to, Personal Computers (PCs), tablet devices, smart wearable devices, Personal Digital Assistants (PDAs), voice-activated assistants, Virtual Reality (VR) devices, smartphones, laptops, and the like.

Further, in a specific embodiment, the data sources 106 may correspond to various data sources that may be associated with the users 104 and are responsible for collecting and collating data related to the users 104 and their surroundings. Herein, the data sources 106 may act as a data provider for the server system 102 and a data collector for the users 104. In one embodiment, the data sources 106 can collect data from the users 104 via the network 110. It may be noted that the data sources 106 may be independent institutions that are independent of the users 104 or may be associated with the users 104. In another embodiment, the data sources 106 can include satellites, data gathering stations, sensors, and the like. Thus, the data sources 106 may directly collect data from its environment and provide it to the server system 102 upon receiving a request. Further, in an embodiment, the data sources 106 may be local storage units or cloud/remote storage units. In another embodiment, the data sources 106 may be owned by third-party organizations.

In a non-limiting example, each data source of the data sources 106 may collect and store data pertaining to a particular or specific task. For instance, the data sources 106 may be a data source for collecting and storing payment transaction-specific data. To that end, the data sources 106 may be an issuer server associated with an issuing bank, an acquirer server associated with an acquiring bank, a payment server associated with a payment network, or the like. In another instance, the data sources 106 may be a medical-specific data repository associated with a hospital server that collects and stores a plurality of patient-related details, medical authorities-related details, staff details, medical students' details, and the like. In yet another instance, the data sources 106 for weather forecasting applications, can be weather stations, sensors, radiosondes, aircraft and ships, radar, etc.

In a specific embodiment, the server system 102 receives data from the users 104 through the data sources 106. In another embodiment, the server system 102 receives data from the data sources 106, the data being related or unrelated to the users 104. The server system 102 may store received data in the database 108. It is to be noted that the data stored in the database 108 can be referred to as an input dataset 112.

In one embodiment, the database 108 may be incorporated in the server system 102 or maybe an individual entity connected to the server system 102 or maybe a database stored in cloud storage. In various non-limiting examples, the database 108 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the server system 102 with access to the database 108. In one implementation, the database 108 may be viewed, accessed, amended, updated, and/or deleted by an administrator (not shown) associated with the server system 102 through a Database Management System (DBMS) or Relational Database Management System (RDBMS) present within the database 108. In addition, the database 108 provides a storage location for data and/or metadata obtained from various operations performed by the server system 102.

Further, in a non-limiting implementation, the server system 102 may use the input dataset 112 to train one or more ML models for generating predictions for an event. Thus, in one embodiment, the server system 102 also stores the one or more ML models, such as a set of decision trees 114 and a calibration model 116 in the database 108. Herein, the event can be any of the above-mentioned downstream tasks. Moreover, in one embodiment, the set of decision trees 114 includes at least one decision tree. In another embodiment, the set of decision trees 114 includes an ensemble model including a plurality of decision trees. Examples of ML models that can be used for the set of decision trees 114 include a tree-based model, such as a single decision tree, a random forest model, a gradient boost model, etc. Further, examples for the calibration model 116 include a logistic regression-based model, an isotonic regression-based model, a Support Vector Machine (SVM)-based model, an NN-based model, etc. The process of training the ML models is explained later in the present disclosure.

In various embodiments, the network 110 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 110 may utilize a secure protocol (e.g., Hypertext Transfer Protocol (HTTP), Secure Socket Lock (SSL), and/or any other protocol, or set of protocols for communicating with the various entities depicted in FIG. 1.

In a specific embodiment, the server system 102 may facilitate the managing entity such as an institution to train an ML model such as the set of decision trees 114 to generate a prediction for an event. Herein, the prediction obtained from the set of decision trees 114 is considered to be poorly calibrated. To calibrate this prediction, a post-processing technique is used. As may be understood, in post-processing techniques, the output of the model, i.e., the prediction of the model (e.g., the set of decision trees 114) is modified and re-training of the model is not required. Thus, the server system 102 also facilitates the managing entity to train another ML model such as the calibration model 116 to generate another prediction for the event. This prediction is considered to be a calibrated prediction that is generated based on operating on the prediction obtained from the set of decision trees 114. It is to be noted that throughout the description, for the sake of simplicity of the explanation of the proposed approach, the prediction obtained from the set of decision trees 114 is referred to as an ‘intermediate prediction’, whereas the one obtained from the calibration model 116 is referred to as merely ‘prediction’ which is calibrated.

In one embodiment, for training the set of decision trees 114, the server system 102 has to prepare the input dataset 112 for training. The input dataset 112 may include a plurality of data samples. The process of preparing the input dataset 112 for training the set of decision trees 114 is explained later in the present disclosure. An output of this step can be a feature set for each data sample. Thus, in one embodiment, the server system 102 is configured to access the feature set corresponding to each data sample in the input dataset 112 from the database 108. Further, the server system 102 may be configured to generate the intermediate prediction for the event based, at least in part, on applying the feature set of each data sample on the set of decision trees 114. Herein, the set of decision trees 114 may correspond to a pre-trained ML model. More specifically, the pre-trained ML model can be a single decision tree. Alternatively, the pre-trained ML model can be an ensemble ML model having multiple decision trees.

Each decision tree may include a plurality of nodes. As may be understood, the plurality of nodes includes a root node which is a start point of the decision tree, intermediate nodes, and terminal nodes (otherwise also referred to as ‘leaf nodes’) which are the end points of the decision tree. Thus, it may be understood that when the feature set of a particular data sample is applied to a particular decision tree, then it starts from a root node. Then a decision rule is applied at the root node onto a particular feature of the feature set to determine whether the decision moves towards a right branch or a left branch. This process continues and is applied to almost all the features of the feature set until the flow reaches the leaf nodes and one of the leaf nodes is activated. The activated node is associated with a probability score. In an ensemble model having multiple decision trees such as the set of decision trees 114, this score is aggregated from each decision tree and a cumulative prediction is generated for the event.

For example, in a weather forecasting application, for predicting whether it will rain on a specific day or not, the feature set can include values corresponding to features, such as temperature, humidity, and wind speed. For a condition in which the temperature is less than 25° C. (i.e., it is cooler), humidity is higher than 80%, and the wind pattern is moderate, it can be predicted that it will rain. When this feature set is passed through a decision tree, at the root node, temperature can be checked, and the flow can move to a left branch if the temperature is less than or equal to 25° C. or a right branch if the temperature is more than 25° C. At the end of these branches, intermediate nodes can be formed where another feature is checked such as the wind speed. At each intermediate node, if the wind speed falls in the moderate speed range, then move to a left branch, else move to a right branch. At the end of these branches, new intermediate nodes can be formed where another feature can be checked such as the humidity. At each intermediate node, if the humidity is close to or above 80%, then move to the left branch, else move to the right branch. These nodes are referred to as the leaf nodes as the decision may not spilt the feature set further. A leaf node satisfying the above-mentioned condition is activated, and the probability score associated with that leaf node is considered for generating the prediction for rain. This way, if an ensemble model is used, then multiple decision trees may be generated, and the feature set may be passed to each decision tree. Further, the output of each decision tree may be ensembled (or aggregated) with each other in a predefined proportion to generate the final prediction.

To calibrate the intermediate prediction obtained from the set of decision trees 114, an encoding (i.e., a representation) representing the leaf nodes of each decision tree may be generated. Such an encoding may be obtained for each data sample from the input dataset 112, and when used by the calibration model 116, a new prediction may be generated which is calibrated. Thus, in one embodiment, the server system 102 is configured to identify an activated leaf node from each decision tree based, at least in part, on the intermediate prediction. Herein, the activated leaf node may indicate a leaf node of one or more leaf nodes of the corresponding decision tree contributing to the intermediate prediction.

In another embodiment, the server system 102 is configured to generate a tree-based encoding indicating an encoded representation of the set of decision trees 114 for each data sample based, at least in part, on an encoding type and the activated leaf node from each decision tree. The process of generating the tree-based encoding is explained later in the present disclosure. In yet another embodiment, the server system 102 is configured to generate the prediction for the event. In a specific embodiment, the server system 102 may generate the prediction using the calibration model 116. Moreover, it is to be noted that the prediction is calibrated by the calibration model 116 based on the tree-based encoding for each data sample. The process of training the calibration model 116 and using it to generate the prediction for the event that is calibrated is also explained later in the present disclosure.

In an embodiment, it may be noted that the methods and systems proposed in the present disclosure can be used in any domain or industry to perform any downstream tasks. The industries may include healthcare, retail, media, travel, crime detection, financial industry, and the like.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices are shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 110, which may be specifically configured, via executable instructions, to perform steps as described herein, and/or embodied in at least one non-transitory computer-readable media.

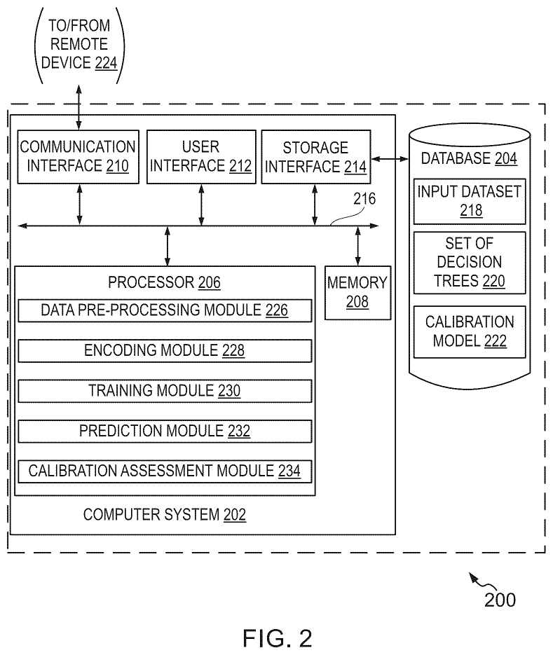

FIG. 2 illustrates a simplified block diagram of a server system 200, in accordance with an embodiment of the present disclosure. The server system 200 is identical to the server system 102 of FIG. 1. In some embodiments, the server system 200 is embodied as a cloud-based and/or SaaS-based (software as a service) architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one embodiment, the database 204 is substantially similar to the database 108 of FIG. 1. In one non-limiting example, the database 204 is configured to store an input dataset 218, a set of decision trees 220, a calibration model 222, and the like. Herein, the input dataset 218, the set of decision trees 220, the calibration model 222 are similar to the input dataset 112, the set of decision trees 114, and the calibration model 116, respectively described in FIG. 1.

As mentioned earlier, the input dataset 218 includes historical data that may be required for training an ML model to generate predictions related to a specific downstream task. For example, when the task is weather forecasting, then the input dataset 218 includes the data samples, with each data sample representing a record of weather conditions at a specific time and location. For instance, the data samples can be hourly or daily observations. In another example of a payment industry, for fraud detection, the input dataset 218 can include data samples, with each data sample representing a financial transaction or account activity on a specific time instant.

In a non-limiting implementation, the set of decision trees 220 is a pre-trained model that is trained to generate predictions related to a particular event. Thus, the training process of this model is not explained herein for the sake of brevity. In another non-limiting implementation, the calibration model 222 is trained to generate the predictions related to the event based on intermediate predictions obtained from the set of decision trees 220. It is to be noted that the intermediate predictions are not provided to the calibration model 222, rather intermediate representations of the set of decision trees 220 are used. The process of generating such intermediate representations is explained further in the present disclosure.

Further, the computer system 202 may include one or more hard disk drives as the database 204. The user interface 212 is an interface, such as a Human Machine Interface (HMI) or a software application that allows a managing entity such as an administrator to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an ATA adapter, a SATA adapter, a SCSI adapter, a RAID controller, a SAN adapter, a network adapter, and/or any component providing the processor 206 with access to the database 204.

The processor 206 includes suitable logic, circuitry, and/or interfaces to execute operations for generating an intermediate prediction for an event, generating a tree-based encoding for a data sample, generating a prediction for the event that is calibrated based on the tree-based encoding, and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 224, such as electronic devices of the users 104, the data sources 106, or communicating with any entity connected to the network 110 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 226, an encoding module 228, a training module 230, a prediction module 232, and a calibration assessment module 234. It should be noted that components, described herein, such as the data pre-processing module 226, the encoding module 228, the training module 230, the prediction module 232, and the calibration assessment module 234 can be configured in a variety of ways, including electronic circuitries, digital arithmetic, and logic blocks, and memory systems in combination with software, firmware, and embedded technologies. Moreover, it may be noted that the data pre-processing module 226, the encoding module 228, the training module 230, the prediction module 232, and the calibration assessment module 234 may be communicably coupled with each other to exchange information with each other for performing the one or more operations facilitated by the server system 200.

In one embodiment, the data pre-processing module 226 includes suitable logic and/or interfaces for accessing the input dataset 218 from the database 204. In another embodiment, the data pre-processing module 226 is configured to generate the feature set for each data sample based, at least in part, on the input dataset 218. The feature set can then be stored back in the database 218 and accessible for future use.

As may be understood, the term ‘dataset’ refers to raw input data that may be used during different stages, such as training, testing, validating, or during deployment of any AI or ML model. However, prior to using the dataset, it is prepared or made suitable for any of the above-mentioned stages by featurization or performing a feature generation operation on the dataset. Generally, the dataset includes multiple data points or data samples. As used herein, the terms ‘data point’ and ‘data sample’, may be used interchangeably, and refer to a single instance or observation within the dataset.

In some embodiments, each data sample may represent a single user or individual. In some other embodiments, based on the nature of the dataset and the problem being addressed, a data sample may represent aggregated or summarized information about multiple users of individuals. However, it is to be noted that each data point or data sample represents a unique combination of features or attributes that describe some aspect of the objective of training the model. During featurization, in one embodiment, these features are extracted from the dataset for each data sample. In another embodiment, new features are generated for each data sample using the various data fields associated with each user in the raw data. Both the extracted features and the newly generated features may correspond to insights, useful information, relevant patterns, and the like associated with the dataset.

Thus, it may be understood that the feature set may be obtained upon preprocessing the input dataset 218 to improve the model's performance. In a non-limiting example, preprocessing the input dataset 218 may include performing several operations on the input dataset 218 to make the input dataset 218 suitable for any stage of the model. For instance, the operations may include removing noise, feature engineering (also referred to as featurization or feature generation), feature selection, data cleaning, handling missing values, normalizing or scaling data, analyzing characteristics of the data, and converting the input dataset 218 into a format that AI or ML models can process. Since these operations are well known in the art, the same has not been described herein for the sake of brevity.

For instance, when the input dataset 218 is for weather forecasting, then various examples of the feature set can include current temperature, minimum temperature, maximum temperature, humidity, wind speed and direction, pressure, precipitation, cloud cover, weather conditions, such as clear, cloudy, rainy, etc., timestamp (i.e., time and date of observation), location (e.g., latitude, longitude, city name, etc.), and the like.

In another instance of fraud detection, various examples of the feature set that may be derived from the input dataset 218 can include transaction amount, time and date of transaction, location of transaction (e.g., IP address, geographical location, etc.), transaction type, cardholder account details, frequency of transactions, merchant details, cardholder behavior patterns, and the like. Various other examples of the feature set can include multifarious data, such as social media data, Know Your Customer (KYC) data, payment data, trade data, employee data, Anti Money Laundering (AML) data, market abuse data, Foreign Account Tax Compliance Act (FATCA) data, fraudulent payment transaction data, and the like.

It is to be noted that the input dataset 218 can be split into a training dataset, a validation dataset, and a testing dataset, each dataset having a different timeline. Thus, the feature set obtained from the input dataset 218 can also include a training feature set, a validation feature set, and a testing feature set derived from the training dataset, the validation dataset, and the testing dataset, respectively. As may be understood, the training dataset and the training feature set are used during a training phase of any AI or ML model, the validation dataset and validation feature set are used during the validation phase of the model, and the testing dataset and the testing feature set used during the testing phase of the model. Once the model is trained, validated, and tested, upon deployment, its operation is tested in real-time on a real-time dataset and a real-time feature set.

In a non-limiting implementation, as the objective of the proposed approach in the present disclosure is to generate a calibrated prediction for an event, if the set of decision trees 220 is trained using a training feature set, then the calibration model 222 may have to be trained using a validation feature set. Using the same dataset or feature set for training both these models may have to be avoided to get better results. Further, upon completion of training of the calibration model 222, it may be tested using the testing feature set. For the training of both the models, in some scenarios, an encoded representation or an embedding may be generated based on the feature set. The encoding module 228 may be used for generating the encodings for any of the models.

In one embodiment, the encoding module 228 includes suitable logic and/or interfaces for accessing the feature set from the database 204. As may be understood, the set of decision trees 220 is pre-trained on the prediction of the event. However, during its training process, the encoding module 228 may be configured to generate an encoded representation for each data sample based, at least in part, on the feature set. In an example, the encoding module 228 can generate the encoded representation using encoding generation techniques, such as, but not limited to, one-hot encoding. Further, the encoding generation techniques are well known to a person skilled in the art. To that note, these techniques are not explained herein for the sake of brevity. Further, for training the set of decision trees 220, the feature set and/or the encodings can be provided to the training module 230 for training the set of decision trees 220.

In one embodiment, the training module 230 includes suitable logic and/or interfaces for performing an intermediate set of operations for training the set of decision trees 220 to generate an intermediate prediction for the event. It is to be noted that the intermediate set of operations may be performed iteratively until intermediate convergence criteria are met. The training module 230 may perform the intermediate set of operations onto the set of decision trees 220 based on the training dataset and the training feature set. It is to be noted that, the process of training any tree-based model is well-known to a person skilled in the art. To that note, this process is not repeated herein for the sake of brevity. Upon completion of the training of the model such as the set of decision trees 220, the model may be stored in the database 204 which is accessible for future use.

In one embodiment, the prediction module 232 includes suitable logic and/or interfaces for generating the intermediate prediction for the event based, at least in part, on applying the feature set of each data sample on the set of decision trees 220. In such an embodiment, the feature set can include the validation feature set. As may be understood, each decision tree includes the plurality of nodes. As described earlier, the nodes include a root node, intermediate nodes, and leaf nodes. Further, the validation feature set is passed through the set of decision trees 220, for each of the decision trees to culminate in a single leaf node of the corresponding decision tree. The leaf node where a particular decision tree of the set of decision trees 220 culminates is activated and hence is referred to as an activated leaf node. Further, an individual decision of the particular decision tree corresponding to the intermediate prediction is generated based on a probability value associated with the activated leaf node. Furthermore, individual decisions from each of the set of decision trees are aggregated to generate the intermediate prediction. The intermediate prediction may be provided to the calibration assessment module 234 for determining a calibration error associated with the intermediate prediction.

In one embodiment, the calibration assessment module 234 includes suitable logic and/or interfaces for extracting an intermediate predicted probability score associated with the intermediate prediction for each data sample from the set of decision trees 220. The intermediate predicted probability score may indicate a likelihood of the event to take place. In some scenarios, this probability score is poorly calibrated and hence requires calibration.

In another embodiment, to determine the extent of calibration required for the calibration of the intermediate prediction, the calibration assessment module 234 is configured to access one or more actual behavior parameters related to the event from the database 204. It is to be noted that one of the examples for the one or more actual behavior parameters includes a calibration accuracy of the intermediate prediction or the calibration accuracy of the intermediate predicted probability score.

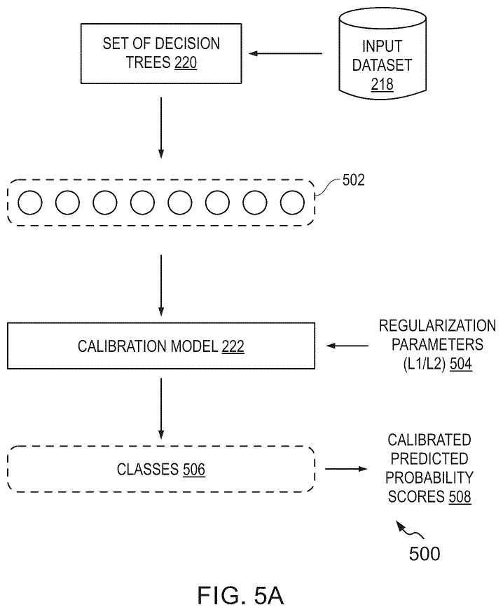

Further, the calibration assessment module 234 may compute a first calibration error for each data sample based, at least in part, on the intermediate predicted probability score for each data sample and the one or more actual behavior parameters. Upon computation of the first calibration error, it may be stored in the database 204. In a non-limiting implementation, a calibration error such as the first calibration error can be computed by generating a reliability diagram. The reliability diagram and the process of computing the calibration error using the reliability diagram are explained later in the present disclosure with reference to FIG. 4.

As may be understood, one of the objectives of the proposed approach is to reduce the first calibration error. In order to do so, an intermediate representation of each of the set of decision trees 220 may be obtained and provided to the calibration model 222 which is trained to generate the prediction which is calibrated using one or more regularization parameters. To generate the intermediate representation, the intermediate prediction is provided to the encoding module 228.

In one embodiment, the encoding module 228 may identify the activated leaf node from each decision tree based, at least in part, on the intermediate prediction. The activated leaf node may indicate a leaf node of the one or more leaf nodes of the corresponding decision tree contributing to the intermediate prediction. As may be understood, the intermediate prediction is obtained by aggregating intermediate predicted probability scores from each decision tree in the set of decision trees 220. These intermediate predicted probability scores are associated with the leaf nodes. If the leaf nodes from each decision tree are accessed or identified, then they can be encoded to generate the intermediate representation for each decision tree based on the respective intermediate predicted probability scores. These intermediate representations may be concatenated with each other to generate a final encoding for the set of decision trees 220 which is also referred to as a ‘tree-based encoding’. It is to be noted that, the term ‘leaf-based encoding’ is used to refer to the intermediate representation of each decision tree.

Thus, the encoding module 228 may generate a tree-based encoding indicating an encoded representation of the set of decision trees 220 for each data sample based, at least in part, on an encoding type and the activated leaf node from each decision tree. To generate the tree-based encoding for each data sample, in one embodiment, the encoding module 228 may generate a set of leaf-based encodings for the set of decision trees 220 based, at least in part, on the encoding type and the one or more leaf nodes in each decision tree. Herein, each leaf-based encoding may indicate a leaf-level encoded representation of each decision tree for each data sample.

In another embodiment, to generate a leaf-based encoding of the set of leaf-based encodings for a particular decision tree of the set of decision trees 220, the encoding module 228 is configured to determine the encoding type. In a non-limiting implementation, the encoding module 228 may determine the encoding type for encoding the decision tree to be a position-based encoding based, at least in part, on first predefined criteria. In a non-limiting example, the first predefined criteria can include a condition in which the input dataset 218 is a large dataset. More specifically, the input dataset 218 can be considered to be a large dataset when a predefined count of the plurality of data samples within the input dataset 218 is at least equal to a predefined threshold. Herein, the predefined threshold can be any large number, e.g., a thousand data samples.

Further, the term ‘position-based encoding’ refers to a type of encoding that captures a position and an order in which the leaf nodes are arranged in each decision tree. Further, in one embodiment, in response to determining that the encoding type is the position-based encoding, the encoding module 228 may generate a position-type leaf-based encoding representing the leaf-based encoding for the decision tree. Furthermore, to generate the position-type leaf-based encoding, the encoding module 228 is configured to assign a first label to the activated leaf node and a second label to each of remaining leaf nodes of the one or more leaf nodes of the decision tree. The encoding module 228 may concatenate the first label and the second label of each of the remaining leaf nodes based, at least on a position of each of the one or more leaf nodes in the decision tree to obtain the position-type leaf-based encoding of the decision tree. In a non-limiting example, the size of the position-type leaf-based encoding representing a particular decision tree corresponds to the number of leaf nodes in the corresponding decision tree.

In a non-limiting example, the position-type leaf-based encoding can be generated using a one-hot encoding mechanism. As may be understood, the one-hot encoding mechanism converts categorical data into a numerical format that ML models process. Each category is represented by a binary vector, where a ‘1’ indicates the presence of the category, and all the other categories are represented by ‘0’. For example, if there are three categories, such as green, red, and blue, then green can be represented as [1, 0, 0], red as [0,1,0], and blue as [0, 0, 1]. This process is further elaborated later in the present disclosure.

In yet another embodiment, to generate the leaf-based encoding of the set of leaf-based encodings for a particular decision tree, the encoding module 228 may determine the encoding type for encoding the decision tree to be a weight-based encoding based, at least in part, on second predefined criteria. In a non-limiting example, the second predefined criteria can include a condition in which the input dataset 218 is a small dataset. More specifically, the input dataset 218 can be considered to be a small dataset when the predefined count of the plurality of data samples within the input dataset 218 is less than a predefined threshold. Herein, the predefined threshold can be any number, e.g., a few hundred data samples.

Further, the term ‘weight-based encoding’ refers to a type of encoding that encodes the decision tree using a weight parameter associated with activated leaf nodes. Thus, in one embodiment, in response to determining that the encoding type is the weight-based encoding, the encoding module 228 is configured to generate a weight-type leaf-based encoding representing the leaf-based encoding for the decision tree. Furthermore, to generate the weight-type leaf-based encoding, the encoding module 228 is configured to extract the weight parameter associated with the activated leaf node from the decision tree. The encoding module 228 may assign the extracted weight parameter to the leaf-based encoding of the decision tree to obtain the weight-type leaf-based encoding. In a non-limiting example, the weight parameter can be a real number. Herein, the size of the weight-type leaf-based encoding representing the decision tree is independent of the number of leaf nodes in the corresponding decision tree.

Further, the encoding module 228 may concatenate the set of leaf-based encodings to obtain the tree-based encoding for each data sample. Upon obtaining the tree-based encoding for each data sample, the calibration model 222 may have to be trained to generate the prediction for the event, the prediction being calibrated. Thus, the encoding module 228 may provide the tree-based encoding of each data sample to the training module 230

In one embodiment, the training module 230 is configured to access a training feature set for each training data sample of a training dataset from the database 204. In such an embodiment, the validation feature set that is used to generate the intermediate prediction through the set of decision trees 220, is used as the training feature set for training the calibration model 222. Thus, henceforth, the term ‘training feature set’ corresponds to the validation feature set that was used to generate the intermediate prediction by the set of decision trees 220. Similarly, the terms ‘training dataset’ and ‘training data sample’, henceforth, used throughout the description, refer to the validation dataset, and the validation data sample, respectively that are used for generating the intermediate prediction. In a non-limiting implementation, the training feature set includes ground truth labels.

In another embodiment, the training module 230 is configured to generate a plurality of training tree-based encodings for a plurality of training data samples, respectively of the training dataset. In a non-limiting implementation, to generate the plurality of tree-based encodings, the training module 230 is configured to perform the steps of generating the intermediate prediction, identifying the activated leaf node from each decision tree, and generating the tree-based encoding for each data sample. In yet another embodiment, the training module 230 is configured to train the calibration model 222 to generate the prediction for the event that is calibrated. Herein, training the calibration model 222 includes performing a set of operations iteratively until convergence criteria are met. In a non-limiting implementation, the set of operations can include: (i) initializing the calibration model 222 based, at least in part, on one or more calibration model parameters; (ii) generating, by the calibration model 222, a calibrated predicted probability score for each training data sample based, at least in part, on the plurality of training tree-based encodings and the one or more calibration model parameters, the calibrated predicted probability score indicating a likelihood of an occurrence of the event; (iii) generating, by the calibration model 222, the prediction for the event based, at least in part, on the calibrated predicted probability score and an event threshold, the prediction including a label associated with the event; (iv) computing, by the calibration model 222, a regularized loss for each training data sample based, at least in part, on the calibrated predicted probability score, the ground truth labels, and a regularized loss function; and (v) optimizing the one or more calibration model parameters based, at least in part, on the regularized loss. In a non-limiting example, the optimization step can be performed based, at least on a backpropagation of the regularized loss.

In an embodiment, the convergence criteria can include saturation of the regularized loss. In an embodiment, the regularized loss may saturate after a plurality of iterations of the set of operations is performed. Herein, saturation may refer to a stage in the model training process after a certain number of iterations where a loss value (e.g., the regularized loss) becomes constant, i.e., the difference in the regularized loss for one iteration and its subsequent iteration becomes the same or negligible. The loss of any model is associated with model performance, so, the less the loss the better the model performance. Once the convergence criteria are met, the calibration model 222 can generate the calibrated predicted probability score that is highly accurate, thereby generating a highly accurate prediction for the event. This prediction is also considered to be calibrated.

In another embodiment, the one or more calibration model parameters may be initialized based at least on the type of the model chosen for the calibration model 222. In general, the one or more calibration model parameters can include, but not be limited to, coefficients or weights associated with each feature, bias terms, regularization parameters, and the like. In another embodiment, the one or more calibration model parameters can also include hyperparameters, such as leaning rate, epochs, kernel depth for SVM-based models, depth of trees for decision tree-based models, a number of layers, and a number of neurons in a hidden layer of NN-based models, batch size, and the like. The process of training the calibration model 222 to generate the prediction for the event that is calibrated is explained in detail using an example, later in the present disclosure.

Once the calibration model 222 is trained, its operation may be tested by providing the testing dataset as input to the calibration model 222. Thus, the calibration model 222, after training, is provided to the prediction module 232. In one embodiment, the prediction module 232 is configured to generate a plurality of testing tree-based encodings for a plurality of testing data samples, respectively of the testing dataset.

As may be understood, the prediction module 232 may also be configured to generate the prediction. The prediction is calibrated by the calibration model 222 based on the tree-based encoding. In a specific embodiment, when the testing dataset is used as the input dataset 218, the prediction module 232 may generate the prediction for the event based, at least on a testing tree-based encoding for each testing data sample.

In some embodiments, the prediction module 232 also computes a regularized loss in the prediction of the calibration model 222 using the regularized loss function. This regularized loss corresponds to an error in the calibration model 222 while generating the prediction, during the testing phase. Similar steps may be performed during the deployment of the calibration model 222 and calibrated predictions can be obtained for any dataset that requires usage of the set of decision trees 220.

In some other embodiments, the prediction obtained from the calibration model 222 can be assessed to check for a closeness of the prediction with the one or more actual behavior parameters related to the event. Thus, in one embodiment, the calibration assessment module 234 is configured to extract a predicted probability score associated with the prediction for each data sample from the calibration model 222. The predicted probability score can indicate a calibrated likelihood of the event to take place. Thus, it is to be noted that the predicted probability score is the calibrated predicted probability score. In another embodiment, the calibration assessment module 234 is configured to compute a second calibration error for each data sample based, at least in part, on the predicted probability score for each data sample and the one or more actual behavior parameters. Upon computation of the second calibration error, the second calibration error may be stored in the database 204. In a non-limiting implementation, a calibration error such as the second calibration error can be computed by generating the reliability diagram. The reliability diagram and the process of computing the calibration error using the reliability diagram are explained later in the present disclosure with reference to FIG. 4.

In yet another embodiment, the calibration assessment module 234 is configured to access the first calibration error and the second calibration error for each data sample from the database 204. Further, the calibration assessment module 234 is configured to compute an improvisation factor for each data sample based, at least in part, on the first calibration error and the second calibration error. In a non-limiting example, the improvisation factor can indicate an extent of a positive impact on the calibration of the intermediate prediction. It is to be noted that the second calibration error is supposed to be less than the first calibration error if the prediction obtained from the calibration model 222 is well calibrated. Thus, by computing the improvisation factor, how well the prediction is calibrated is determined. In a non-limiting example, the improvisation factor can be a difference between the first calibration error and the second calibration error. Moreover, to conclude that the prediction is well calibrated, the second calibration error may have to be less than the first calibration error.

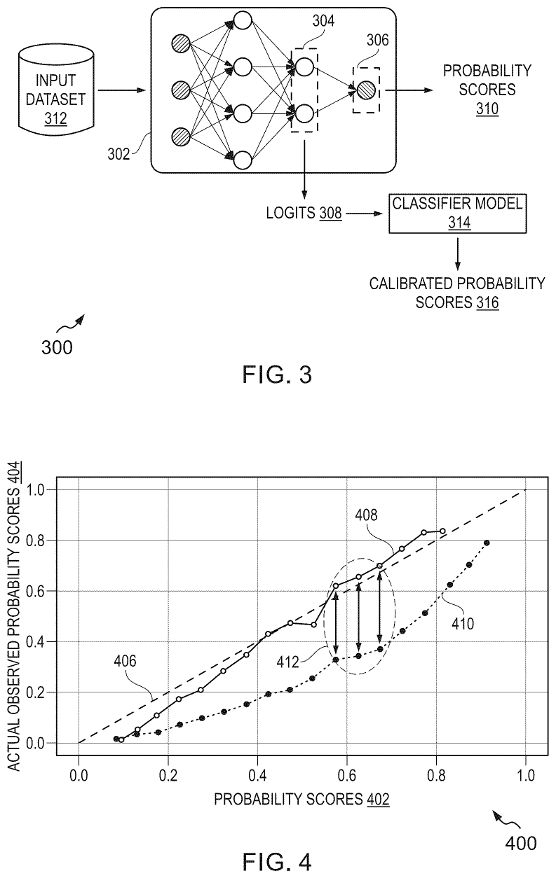

FIG. 3 illustrates a block diagram depicting a calibration process 300 applied on a Neural Network (NN)-based model such as an NN-based model 302, in accordance with an embodiment of the present disclosure. One of the conventional approaches used to implement the calibration process 300 that is applied on the NN-based model 302 is a Platt scaling. It is to be noted that, with reference to FIG. 3, Platt scaling is explained. As may be understood, in the NN-based model 302, a layer 304 just before the classification layer 306 has embeddings or representations (i.e., logits 308). It is to be noted that conventionally, on these values, an activation function, such as a sigmoid function or a softmax function is applied to generate probability scores 310 indicating the classification results for an input dataset 312. These representations are such that, another classifier model (see, 314) can be trained to generate calibrated probability scores 316. An example of the classifier model 314 that is best suited for calibration is a logistic regression model. It is to be noted that the input dataset 312 can be similar to the input dataset 218 and the classifier model 314 is similar to the calibration model 222 described in FIG. 2. In a non-limiting example, when Platt scaling is applied to the logistic regression model, Platt scaling tries to fit a sigmoid function to map the logits 308 to values between 0 and 1, which can be interpreted as probabilities. This can be presented as follows:

$$P ( y = 1 \vert f ( x ) ) = \frac{1}{{e}^{Af ( x ) + B}} \qquad Eqn . ( 1 )$$

Herein, f(x) is the raw score (i.e., the logits 308) from the NN-based model 302. A and B are parameters learned from the data. By applying this equation, Platt scaling is applied on the logits 308 which generates probability scores that are calibrated. As a result, the interpretability of the NN-based model 302 can be improved such that these scores reflect actual probabilities.

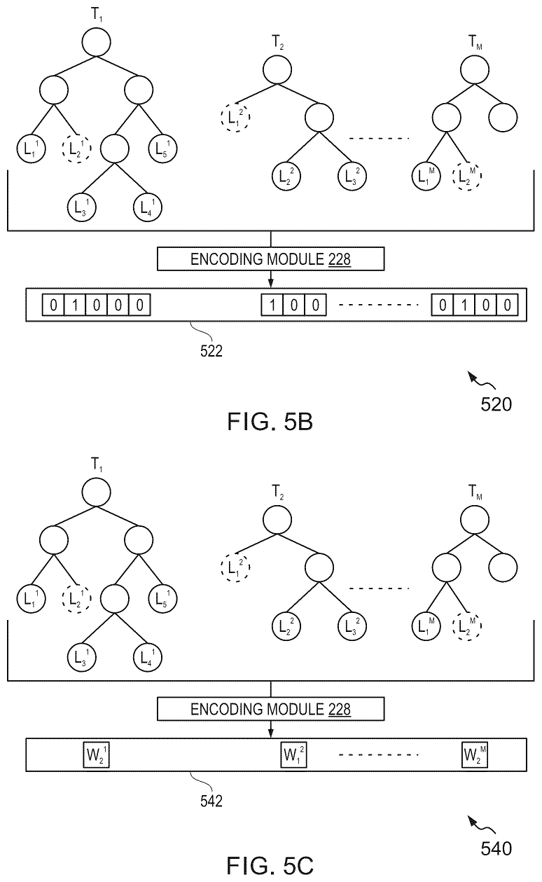

In a non-limiting implementation, this same approach can be applied to the set of decision trees 220. However, the set of decision trees 220 is not associated with any representations similar to the logits 308. As a result, in the present disclosure, a new approach is proposed using which a tree-based encoding for each data sample representing the set of decision trees 220 is generated. This tree-based encoding is then used to generate calibrated predicted probability scores, providing calibrated predictions. This process is already explained with reference to FIGS. 1 and 2 and is further elaborated later in the present disclosure using an example with reference to FIGS. 5A-5C.

FIG. 4 illustrates a graphical representation of a reliability diagram 400 for an example scenario, in accordance with an embodiment of the present disclosure. As used herein, the term ‘reliability diagram’ refers to a plot generated using a software tool to evaluate the calibration of a probabilistic classification model. The reliability diagram 400 compares the predicted probability scores of an event with actual observed frequencies. The reliability diagram 400 plots the predicted probability scores 402 such as the intermediate predicted probability score or the calibrated predicted probability score on the x-axis. Further, an actual behavior parameter such as the actual observed probability scores 404 indicating the calibration accuracy are plotted on the y-axis. As used herein, the term ‘calibration accuracy’ refers to the proportion of true positive events within each probability bin. For example, if a model generates a predicted probability score of 0.8 for a set of events, then the calibration accuracy checks how often events with this predicted probability score actually occur. Thus, it may be understood that in the reliability diagram 400, the calibration accuracy reflects the alignment between the predicted probability scores and the actual outcomes.

Referring to FIG. 4, it may be observed that, in the example scenario, a curve 406 indicates an identity function where the confidence of the prediction and the calibration accuracy are identical. This can be referred to as an ideal condition of a model. Any deviation from this curve (i.e., a perfect diagonal) is miscalibration. Further, a curve 408 indicates a variation of a confidence of a model computed for each data sample which depends on the predicted probability values. This curve 408 may indicate the expected behavior of the model which is supposed to be close to the identity function (i.e., the curve 406). A curve 410 indicates a variation in the calibration accuracy of the model for each data sample which are also probability values. This curve 410 may indicate the actual behavior of the model which is highly deviated from the expected behavior or the ideal behavior. Thus, a calibration error is observed which needs to be corrected.

Suppose the curve 408 indicates the intermediate probability scores generated by the set of decision trees 220 for the data samples in the input dataset 218. Further, the curve 410 represents the one or more actual behavior parameters which is the calibration accuracy of the intermediate prediction. Thus, from the curves 408 and 410 it is clear that the intermediate probability scores are poorly calibrated. In a non-limiting example, the calibration assessment module 234 computes the first calibration error using the equation for an Expected Calibration Error (ECE) which is as follows:

$$ECE = {\sum }_{m = 1}^{M} \frac{\vert {B}_{m} \vert}{N} \cdot \vert acc ( {B}_{m} ) - conf ( {B}_{m} ) \vert \qquad Eqn . ( 2 )$$

Herein, M represents a number of bins, Bₘ represents the m^{th} bin, N is the total number of samples in the input dataset 218 and |Bₘ| represents the number of samples in the m^{th} bin, acc (Bₘ) is calibration accuracy and conf (Bₘ) is the confidence of the m^{th} bin.

It is to be noted that the lines 412 can be considered to be representing this error. In another non-limiting example, to better understand the first calibration error, an approximation of the area between the two curves 408 and 410 can be computed using the following equation:

$$Sum\_ECE = {\sum }_{m = 1}^{M} \vert acc ( {B}_{m} ) - conf ( {B}_{m} ) \vert \qquad Eqn . ( 3 )$$

It is to be noted that the lower the value for this equation, the better is the calibration. In yet another non-limiting example, the calibration can also be computed using a Brier score which can be computed using the following equation:

$$Brier score = \frac{1}{N} {\sum }_{i = 1}^{N} {( {f}_{i} - {o}_{i} )}^{2} \qquad Eqn . ( 4 )$$

Herein, N is the total number of samples in the input dataset, fᵢ represents the output probability (i.e., the intermediate predicted probability score) from the model (e.g., the set of decision trees 220), and oᵢ is the actual output (ground truth).

Similarly, the calibration assessment module 234 can also compute the second calibration error using any of the equations Eqn. (2), Eqn. (3), and Eqn. (4). Further, based on both these values, the improvisation factor can be computed, and the extent of the positive impact on the calibration obtained upon implementation of the proposed approach may be observed.

FIG. 5A illustrates a block diagram depicting a calibration process 500 applied on a set of decision trees (e.g., the set of decision trees 220), in accordance with an embodiment of the present disclosure. As may be understood, the calibration process 500 proposed in the present disclosure can be applied to a pre-trained model (e.g., the set of decision trees 220 that are pre-trained) to improve their calibration performance. To that note, the calibration process 500 can include a step to initially train the set of decision trees 220 on a training dataset. Thus, the input dataset 218 shown in FIG. 5A can represent the training dataset when the set of decision trees 220 are being trained to generate the intermediate prediction for the event. The training module 230 of the server system 200 can be used to train the set of decision trees 220 on the training dataset. Thereafter, representations such as a plurality of tree-based encodings 502 for a plurality of data samples of the input dataset 218 are obtained. Herein, the plurality of tree-based encodings 502 can be obtained for a validation dataset. Thus, the input dataset 218 in FIG. 5A may represent the validation dataset. The encoding module 228 of the server system 200 can be used to generate the tree-based encodings 502. These representations are then utilized by the training module 230 to train the calibration model 222 to generate the predictions for the events that are calibrated. In a non-limiting implementation, the calibration is based on the Platt scaling approach. However, unlike the Platt scaling, the representations obtained for the set of decision trees 220 is an intermediate representation. In a non-limiting example, the calibration model 222 can be a logistic regression model. Moreover, the training module 230 can also apply regularization parameters such as L1 and/or L2 (see, 504) on the calibration model 222, during the training phase, to further improve the calibration performance. Later, classes (see, 506) associated with the event may be predicted by the calibration model 222 through the prediction module 232 of the server system 200. The classes 506 are associated with calibrated predicted probability scores 508.

It is to be noted that the calibration process 500 is explained using an example scenario such as a pattern classification scenario where pairs of features X and labels Y are considered. Herein, in a non-limiting example, X={x₁, x₂, . . . xₙ} representing n features for each data sample and Y={y₁, y₂ . . . yₖ}, for each data sample in the input dataset 218 which is D_{X,Y}, such that the features are independent and identically distributed with each other. A classification model (i.e., the set of decision trees 220) M_{θ}→P(Y|X) where θ is a set of parameters of the model that is trained on a subset of D_{X,Y} known as the training dataset. Once the model is trained, it is evaluated on the testing dataset such as T_{XY}. The model is evaluated as M_{θ}(x₁, . . . xₙ) which can be expressed by [symbol] (yᵢ|(x₁, . . . xₙ)) which is the probability of the data sample (which is expressed by n features) for being in the i^{th} class. For perfect calibration, the following conditions may have to hold true.

$$P ( \hat{y} - y \vert \hat{p} - p ) - P ∀ p - [ 0 , 1 ] \qquad Eqn . ( 5 )$$

Herein, ŷ and y are the predicted and true class respectively, and \hat{p} and p signifies the predicted and true probability of the data sample belonging to the class ŷ.

In a non-limiting example, the set of decision trees 220 can use an XGBoost algorithm which can be used to show how the set of decision trees 220 is trained. For training the set of decision trees 220, the training data D_{X,Y} is considered. It is to be noted that this tree-based modeling technique is the most widely used in tabular datasets. This algorithm trains a set of M trees representing the set of decision trees 220 given by T={T₁, T₂ . . . T_{M}} (as shown in FIGS. 5B and 5C). Each of these trees contains several leaf nodes, where the leaf nodes in the i^{th} tree are represented as

$$L = \{ {L}_{1}^{i} , {L}_{2}^{i} … , {L}_{{p}_{i} ,}^{i} \}$$

(as shown in FIGS. 5B and 5C). In a non-limiting example, the set of decision trees 220 is being trained using a loss such as a cross-entropy loss which in the binary case can be given by:

$$Loss = - ( y log ( p ) + ( 1 - y ) log ( 1 - p ) ) \qquad Eqn . ( 6 )$$

In another non-limiting example, a loss for a multiclass case can be defined by:

$$Loss = - {\sum }_{c = 1}^{M} {y}_{o , c} log ( {p}_{o , c} ) \qquad Eqn . ( 7 )$$

Herein, y and p are the binary class indicator and predicted probability score, respectively. For the multi-class case, o and c are the output probability vector and the ground truth vector, respectively. Once the ensemble model T has been trained, in each leaf node of each tree Tᵢ a weight

$${w}_{j}^{{T}_{i}}$$

is associated with the j^{th} leaf node of the tree. During inferencing of a testing data sample, the data sample is put into each of the trees in the ensemble model T, and the weight of the subsequent leaf nodes that it evaluates to is used to calculate the final score (i.e., the calibrated predicted probability score) for that data sample across all the trees in the ensemble model T such as the set of decision trees 220.

Further, as described earlier, one of the objectives of the proposed approach is to use the intermediate representations (i.e., the tree-based encodings 502) of the model (i.e., the set of decision trees 220) in the calibration model 222 such as the logistic regression model and train it on the validation dataset V_{X,Y}. These intermediate representations can be determined based on the encoding type that may be considered for encoding the set of decision trees 220. As may be understood, the encoding type can be the position-based encoding when the input dataset 218 is a large dataset and can be the weight-based encoding when the input dataset 218 is a small dataset. The process of generating the tree-based encodings 502 using the position-based encoding is explained with reference to FIG. 5B. Similarly, the process of generating the tree-based encodings 502 using the weight-based encoding is explained with reference to FIG. 5C.

Further, once the tree-based encodings 502 are obtained, the tree-based encodings 502 can be used as training data (along with the original label space Y) for the calibration model 222 such as the logistic regression model. It is to be noted that the training module 230 trains the calibration model 222 using a sigmoid activation function. In a non-limiting example, the sigmoid activation function can be as follows:

$$σ ( z ) = \frac{1}{1 + {e}^{- z}} \qquad Eqn . ( 8 )$$

To that note, in a non-limiting implementation, the principle of Platt scaling is applied by training the logistic regression model. The logistic regression model has a weight assigned for each of the input encoding values in the encoded vector (i.e., the tree-based encodings 502). In a non-limiting implementation, the logistic regression model for the tree-based encodings 502 may be expressed as follows:

$$P ( {Y}_{i} = 1 \vert {X}_{i} ) = \frac{exp ( {β}_{0} + {β}_{1} {e}_{i} + {β}_{2} {e}_{2} + … + {β}_{m} {e}_{m} )}{1 + exp ( {β}_{0} + {β}_{1} {e}_{i} + {β}_{2} {e}_{2} + … + {β}_{m} {e}_{m} )} \qquad Eqn . ( 9 )$$

Herein, βᵢ and eᵢ are the coefficient and a weight parameter associated with each leaf node for the (i−1)^{th} tree, respectively. For the tree-based encodings 502, there will be M+1 coefficients trained with the calibration model 222. Further, as may be understood, L1 and L2 regularization can be applied to the weights of the logistic regression model where a regularized loss with L1 regularization can be expressed as follows:

$$Loss = Error ( Y - \hat{Y} ) + λ {\sum }_{1}^{n} \vert {w}_{i} \vert \qquad Eqn . ( 10 )$$

Similarly, in another non-limiting implementation, the regularized loss with L2 regularization can be expressed as follows:

$$Loss = Error ( Y - \hat{Y} ) + λ {\sum }_{1}^{n} {w}_{i}^{2} \qquad Eqn . ( 11 )$$

Herein, wᵢ is the i^{th} weight parameter of the calibration model 222. Moreover, it is to be noted that L1 and L2 regularization adds a penalty term to the loss function, thereby shrinking the weight values of the model to prevent overfitting of the model. In addition, it improves model calibration by achieving optimal accuracy.

FIG. 5B illustrates a schematic representation of a process 520 of generating a tree-based encoding (e.g., a position-type leaf-based encoding 522) for a data sample, in accordance with an embodiment of the present disclosure. As may be understood, a model inference of a particular data sample can be obtained and encoded into a representation (i.e., the position-type leaf-based encoding 522) so that it can be consumed by the calibration model 222 which works as a post-processing calibrator. In a non-limiting example, consider a validation dataset V_{X,Y} (which is a subset of D_{X,Y}) and the iₜₕ sample vᵢ in this subset is given as an input to the set of decision trees 220, i.e., T={T₁, T₂ . . . T_{M}}. Each of the m trees will result in the activation of one leaf node such as

$${L}_{2}^{1}$$

of T₁, and thus there will be m leaf nodes activated for the entire ensemble model T such as

$$\{ {L}_{2}^{1} , {L}_{1}^{2} … … {L}_{2}^{M} \} .$$

As shown in FIG. 5B, let the total number of leaf nodes in the iₜₕ tree in the ensemble model T be pᵢ where the set of leaf nodes can be represented as

$$\{ {L}_{1}^{i} , {L}_{2}^{i} … {L}_{{p}_{i}}^{i} \} .$$

Thus, the encoding of leaf nodes in this tree can be of size pᵢ. As shown in FIG. 5B, if for generating the position-type leaf-based encoding 522, a one-hot encoding mechanism is used, then the encoding contains zeros for all the leaf nodes, except the one that is activated by that input sample. Further, all the encodings for the M trees can be concatenated providing the tree-based encoding 522 for the set of decision trees 220 (i.e., the ensemble model T) and that becomes the input for the calibration model 222.

FIG. 5C illustrates a schematic representation of a process 540 of generating a tree-based encoding (e.g., a weight-type leaf-based encoding 542) for a data sample, in accordance with another embodiment of the present disclosure. In some scenarios, the position-type leaf-based encoding 522 can be very long. For instance, in scenarios in which the set of decision trees 220 has a large number of trees. To produce a much more compact representation, the weight-type leaf-based encoding 542 can be used. As described earlier, in the weight-type leaf-based encoding 542, the weight parameter for each leaf node is used to compress the size of the tree-based encoding. In other words, the 1's in the position-type leaf-based encoding 522 is replaced by the weights assigned to the leaf nodes, in their respective trees, and zeros are eliminated. As shown in FIG. 5B, only one value for each tree-based encoding, which is the jₜₕ weight wⱼ^{T}^{ᵢ} of the tree Tᵢ, given that this is the activated leaf node which is activated by the validation sample vᵢ. Thus, the total size of the tree-based encoding can be m, which is the total number of trees in the set of decision trees 220 (i.e., the ensemble model T).

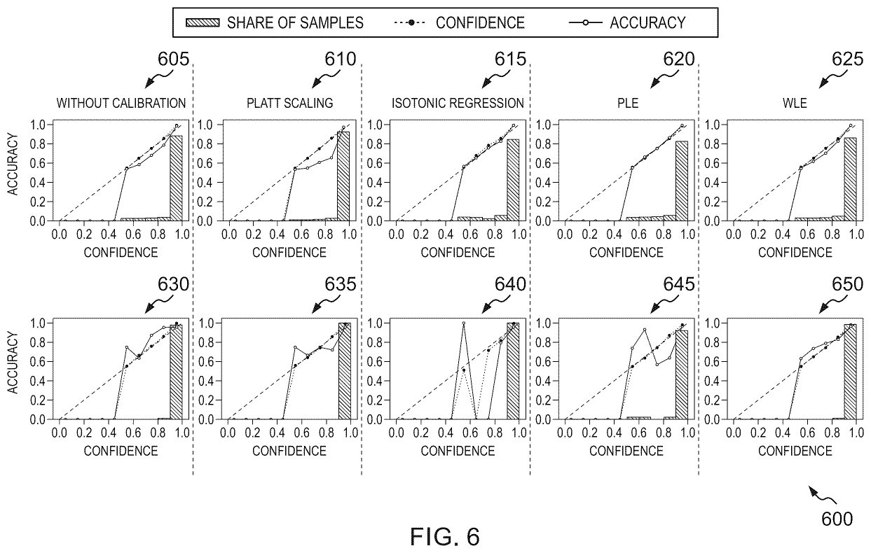

FIG. 6 illustrates a graphical representation 600 of reliability diagrams 605, 610, 615, 620, 625, 630, 635, 640, 645, and 650 for different calibration processes implemented as an experimental setup, in accordance with an embodiment of the present disclosure. As may be understood, a reliability diagram can be used to measure a calibration error (such as the first calibration error and the second calibration error) with probabilistic classification models. One or more experiments may be conducted to verify the same. Measuring the calibration error helps in reducing it to improve the calibration of the model. In a non-limiting implementation of the present disclosure, the probabilistic classification models include the set of decision trees 220 whose predicted probability scores require calibration.

In a non-limiting example, the experimental setup includes performing two subsequent experiments in order to show the efficacy of the calibration process such as the calibration process 500 proposed in the present disclosure. The steps of the experiments can be as follows:
1. An ensemble of M models T={T₁, T₂ . . . T_{M}} (i.e., the set of decision trees 220) using the XGBoost algorithm. The training dataset from the input dataset D (i.e., the input dataset 218) can be used for training.
2. The tree-based encodings 502 can be generated and used as an input to the calibration model 222 such as the logistic regression model (otherwise, also referred to as a post-processing calibrator) with either L1 or L2 regularization. This post-processing calibrator is trained on the validation dataset V_{X,Y}.
3. All the experiments are performed using the XGBoost model as the base ensemble unless mentioned otherwise.

Further, the calibration is evaluated using either the equations for ECE or a brier score, i.e., the Eqn. (3) or Eqn. (4). The evaluation of the calibration includes computing the first calibration error and the second calibration error through the calibration assessment module 234. The experiments may be conducted to measure these errors as a part of measuring a calibration performance and a model performance introduced by the calibration process 500 proposed in the present disclosure. Upon measurement of these parameters, the same parameters may be computed for different experimental setups, such as without calibration (see, 605 and 630), using Platt scaling (see, 610 and 635), using isotonic regression for the calibration model 222 (see, 615 and 640), with the position-type leaf-based encoding (henceforth, otherwise also referred to as ‘PLE’) 522 (see, 620 and 645), with the weight-type leaf-based encoding (henceforth, otherwise also referred to as ‘WLE’) 542 (see, 625 and 650), and the like. It is to be noted that these experimental setups are established and implemented for different input datasets that are tabular datasets. In a non-limiting implementation, the input datasets can include class-imbalanced datasets, multiclass datasets, and the like. The class-imbalanced datasets can include a bitcoin dataset, a bankruptcy dataset, a credit card dataset, and the like. The multiclass datasets can include an airline dataset, an electrocardiogram (ECG) dataset, and the like. Thus, it may be understood that the experiments are conducted on publicly available datasets. It is to be noted that the reliability diagrams 605, 610, 615, 620, and 625 are generated for the airline dataset, whereas the reliability diagrams 630, 635, 640, 645, and 650 are generated for the bitcoin dataset.

In a non-limiting implementation, the bitcoin dataset can include bitcoin transactions that are mapped to illicit (scams, malware, terrorist organizations, ransomware, Ponzi schemes, etc.) and licit (exchanges, wallet providers, miners, licit services, etc.) categories. Further, the bitcoin dataset can be presented as a transaction graph with each node being a bitcoin transaction, and an edge representing the flow of bitcoins between two transactions. For example, the bitcoin dataset can include 203,769 nodes or data samples, out of which 4,545 (around 2%) are labeled as illicit, 42,019 (around 21%) samples are labeled as licit, and the rest are unlabeled.

Similarly, the bankruptcy dataset can include data related to bankruptcy predictions made at a particular company. The bankruptcy dataset can include 6819 samples out of which 220 samples correspond to bankruptcy. The bankruptcy dataset is highly imbalanced, and hence it only contains 3.22% class1 samples. There are a total of 95 features, all are continuous. It is to be noted that 4926 samples for training, 870 for validation, and 1023 for testing can be used.

Further, in a non-limiting implementation, the credit card dataset can include transactions made by credit cards in September 2013 by cardholders of a particular location. The credit card dataset can include 284,807 transactions out of which 492 are fraudulent transactions. This dataset is highly unbalanced, it contains only 0.172% of positive samples. There are in total 30 features out of which V1 to V28 are numerical type and are derived from a Principal Component Analysis (PCA) transformation. Further, the dataset also considers time which is the seconds elapsed between each transaction and the first transaction in the data. The dataset can also include amount which is the amount for the transactions, and class which is a binary variable representing the labels.

Further, the airline dataset can include an airline passenger satisfaction survey. The dataset can include information about passenger's flight information such as flight distance, gate location, arrival delay (in minutes), and the like. The dataset can also include personal information, such as gender, customer type, age, and so on, as features. In total, there are 25 features including “satisfaction” representing the label to predict. The dataset has 103,904 entries for training and 25,976 entries as test data.

Furthermore, the ECG dataset can include two sets of heartbeat signals sourced from well-known databases used in heartbeat classification. The dataset can include a sufficient number of samples suitable for training deep neural networks. The signals represent ECG waveforms of normal heartbeats as well as those affected by various arrhythmia and myocardial infarction. These signals are preprocessed and segmented, with each segment corresponding to an individual heartbeat.

It is to be noted that the XGBoost algorithm can be applied on a particular library (i.e., the database 204) to train the ensemble of trees, i.e., the set of decision trees 220 for classification on the training dataset accessed from the library. For the XGBoost algorithm, parameters used can be as follows: (i) the objective is set to “binary: logistic”; (ii) the evaluation metric is set to “Area Under the Precision-Recall Curve (AUC-PR)”; and (iii) early stopping rounds is set to 30. Further, the regularization parameter C is used to adjust the strength of regularization. In a non-limiting implementation, the following parameters C∈{5,1,0.8,0.5,0.1,0.05, 0.01,0.005,0.001} can be used for the regularization. The number of trees can be automatically adjusted by an internal grid search based on the optimization metric early stopping rounds. Furthermore, for calculating parameters related to the model performance, such as Area Under the Curve-Receiver Operating Characteristics (AUC-ROC/AUROC), F1-Score, AUC-PR, and the like a specific module from the library can be used with parameter average being weighted. In a non-limiting implementation, the experimental results are as follows:

TABLE 1
Experimental results for bitcoin dataset

| | Bitcoin dataset | | | |
|---|---|---|---|---|
| | Calibration Performance | | Model Performance | |
| | | Brier | F1 | |
| | ECE | score | Score | AUROC |
| Without Calibration | 0.03902 | 0.00092 | 0.95316 | 0.78799 |
| Position-type | 0.03099 | 0.01060 | 0.94191 | 0.74361 |
| leaf-based encoding | | | | |
| Weight-type | 0.01054 | 0.00165 | 0.96091 | 0.83033 |
| leaf-based encoding | | | | |
| Platt Scaling | 0.034254 | 0.034254 | 0.95302 | 0.78744 |
| Isotonic Regression | 0.03716 | 0.00038 | 0.95412 | 0.79184 |

TABLE 2
Experimental results for bankruptcy dataset

| | Bankruptcy Dataset | | | |
|---|---|---|---|---|
| | Calibration Performance | | Model Performance | |
| | | Brier | F1 | |
| | ECE | score | Score | AUROC |
| Without Calibration | 0.04030 | 0.00759 | 0.95651 | 0.89108 |
| Position-type | 0.00780 | 0.00840 | 0.95816 | 0.89374 |
| leaf-based encoding | | | | |
| Weight-type | 0.00970 | 0.00718 | 0.96073 | 0.89148 |
| leaf-based encoding | | | | |
| Platt Scaling | 0.03230 | 0.00001 | 0.98361 | 0.50000 |
| Isotonic Regression | 0.03230 | 0.00001 | 0.96904 | 0.83941 |

TABLE 3
Experimental results for credit card dataset

| | Credit card Dataset | | | |
|---|---|---|---|---|
| | Calibration Performance | | Model Performance | |
| | | Brier | F1 | |
| | ECE | score | Score | AUROC |
| Without Calibration | 0.00920 | 0.00014 | 0.99930 | 0.93929 |
| Position-type | 0.00010 | 0.00009 | 0.99940 | 0.93818 |
| leaf-based encoding | | | | |
| Weight-type | 0.00010 | 0.00005 | 0.99948 | 0.93953 |
| leaf-based encoding | | | | |
| Platt Scaling | 0.00060 | 0.00001 | 0.99934 | 0.84456 |
| Isotonic Regression | 0.00030 | 0.00017 | 0.99945 | 0.91041 |

TABLE 4
Experimental results for airline dataset

| | Airline dataset | | | |
|---|---|---|---|---|
| | Calibration Performance | | Model Performance | |
| | | Brier | F1 | |
| | ECE | score | Score | AUROC |
| Without Calibration | 0.01279 | 0.01079 | 0.94895 | 0.94675 |
| Position-type | 0.00695 | 0.01591 | 0.94745 | 0.94592 |
| leaf-based encoding | | | | |
| Weight-type | 0.00410 | 0.01274 | 0.94995 | 0.94787 |
| leaf-based encoding | | | | |
| Platt Scaling | 0.01279 | 0.01079 | 0.94909 | 0.94729 |
| Isotonic Regression | 0.00483 | 0.01418 | 0.94776 | 0.94456 |

TABLE 5
Experimental results for ECG dataset

| | ECG Dataset | | | |
|---|---|---|---|---|
| | Calibration Performance | | Model Performance | |
| | | Brier | F1 | |
| | ECE | score | Score | AUROC |
| Without Calibration | 0.01296 | 0.00180 | 0.97928 | 0.98121 |
| Position-type | 0.00260 | 0.00349 | 0.98121 | 0.99443 |
| leaf-based encoding | | | | |
| Weight-type | 0.00109 | 0.00365 | 0.98224 | 0.99483 |
| leaf-based encoding | | | | |
| Platt Scaling | 0.00227 | 0.00105 | 0.97919 | 0.99402 |
| Isotonic Regression | — | — | — | — |

As mentioned earlier, the results are observed for different experimental setups. Thus, Table 1 to Table 5 shows the results of models trained with and without calibration on each of the different datasets. It is noted that the results shown in Table 1 to Table 5 are approximate in nature and may vary by a factor of ±5% due to various experimental conditions. The parameters measured for checking the calibration performance include ECE and Brier score. The later results are in much more compact embeddings, however the former exhibits some advantages in terms of the results. Further, it may be observed that results obtained with the position-type leaf-based encoding 522 possess better ECE (in most cases), whereas with the weight-type leaf-based encoding 542 much better brier scores are obtained. It may be noted that while ECE is a metric directly measuring calibration errors, the brier score is more of a loss function that measures the accuracy of model predictions. This suggests that the calibration model 222 with the position-type leaf-based encoding 522 performs better in terms of model calibration, while the calibration model 222 with the weight-type leaf-based encoding 542 performs better in terms of model performance (i.e., having better F1 scores as shown in Table 1 to Table 3). Another observation can be that the calibration model 222 with the weight-type leaf-based encoding 542 outperforms all the other approaches when evaluated on the ECE and the F2 score, on all the input datasets except for the bankruptcy dataset.

Further, it is to be noted that the model calibration often has an effect on the model performance in terms of accuracy. It may be observed that high-performing models often suffer from calibration, and the process of calibration itself may negatively affect the model performance. Table 1 to Table 3 shows two important performance metrics namely AUROC and FI Score, which are well-known metrics for model performance.

In some embodiments, the reliability diagrams 605, 610, 615, 620, 625, 630, 635, 640, 645, and 650 may be plotted to compute the parameters such as the ECE and Brier score for different experimental setups. FIG. 6 shows the relationship between accuracy and confidence in different bins of probabilities. Therefore, these are useful for understanding the variations in calibration on prediction bin levels. FIG. 6 shows experiments done on the airline dataset, where four different types of calibration processes are being applied including two proposed methods using the two different tree-based encodings. Similarly, FIG. 6 shows experiments done on the bitcoin dataset with the four different calibration processes. It is to be noted that using the reliability diagrams 605, 610, 615, 620, 625, 630, 635, 640, 645, and 650, a visual observation of the different calibration processes can be made. One such observation is that Platt scaling (see, 610 and 635) pushes all the samples to the last bin, whereas isotonic regression pulls away samples from the last bin and distributes them among the other bins (see, 615 and 640). The calibration processes using the position-type leaf-based encoding 522 and weight-type leaf-based encoding 542 are observed to behave similarly to isotonic regression signifying that the proposed approach and isotonic regression are able to reduce the calibration error, as shown from the experiment results in Table 1 to Table 3. In addition to this, for the input datasets containing inherent class imbalance, namely for the bitcoin dataset, the credit card dataset, and the bankruptcy dataset, the isotonic regression method is not being able to align confidence and calibration accuracy across bins, whereas the proposed approach (i.e., the using the PLE 522 and the WLE 542) is being able to achieve it across the bins. It may also be noted that, referring to FIG. 6, calibration is poor in the base model (i.e., without calibration (see, 605 and 630)) since the rate of one class is just 0.172%, however, the proposed approach is being able to improve the alignment of confidence and accuracy, with the tree-based encodings 502 performing the best.

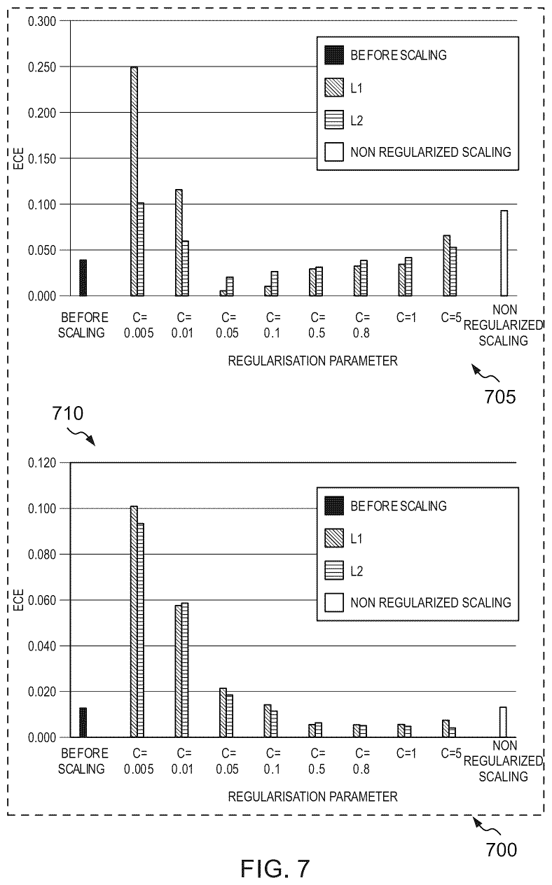

FIG. 7 illustrates a graphical representation 700 depicting a variation of a calibration error such as the ECE with a regularization parameter (i.e., C) for L1 regularization (see, 705) and L2 regularization (see, 710), in accordance with an embodiment of the present disclosure. As described earlier, in accordance with one experimental setup, the regularization parameter C∈{5,1,0.8,0.5,0.1,0.05, 0.01,0.005,0.001}. FIG. 7 shows the variation of the ECE with the application of this parameter on the set of decision trees 220 for the airline dataset being the input dataset 218. As may be understood, the application of the parameter C affects the value of λ in the equations 10 and 11 (i.e., Eqn. (10) and Eqn. (11)).

It is to be noted that a lower value of the parameter C indicates a higher λ being used. Further, the labels “Before Scaling” represent the model without calibration, and “non-regularized scaling” represents the calibration model 222 trained on the tree-based encodings 502 proposed in the present disclosure without regularization. The lesser the value of C, the higher the strength of regularization.

In another experiment, the effect of regularization on the calibration model 222 for different input datasets, such as the airline dataset and the bitcoin dataset is also observed. It is to be noted that, this effect is observed with the XGBoost algorithm being applied on the base ensemble model such as the set of decision trees 220. In a non-limiting implementation, the experimental results for the same are as follows:

TABLE 6
Experimental results with regularization applied to the calibration model

| | Airline dataset | | | Bitcoin dataset | | |
|---|---|---|---|---|---|---|
| | Calibration | | Model | Calibration | | Model |
| | Performance | | Performance | Performance | | Performance |
| | | Brier | F1 | | Brier | F1 |
| | ECE | score | Score | ECE | score | Score |
| Without | 0.01278 | 0.01078 | 0.94894 | 0.03902 | 0.00092 | 0.95315 |
| Calibration | | | | | | |
| Weight-type | 0.01310 | 0.01114 | 0.94659 | 0.09300 | 0.00049 | 0.811044 |
| leaf-based | | | | | | |
| encoding | | | | | | |
| without | | | | | | |
| regularization | | | | | | |
| Weight-type | 0.00547 | 0.01350 | 0.94918 | 0.01054 | 0.001649 | 0.96090 |
| leaf-based | | | | | | |
| encoding with | | | | | | |
| L1 | | | | | | |
| regularization | | | | | | |
| Weight-type | 0.0041 | 0.01274 | 0.94995 | 0.02031 | 0.00290 | 0.95397 |
| leaf-based | | | | | | |
| encoding with | | | | | | |
| L2 | | | | | | |
| regularization | | | | | | |

From Table 6, it may be observed on both these datasets that the proposed approach with the weight-type leaf-based encoding 542 not only improves regularization but also results in superior model performance (i.e., the F1 score is observed to be improved). It is noted that the results shown in Table 6 are approximate in nature and may vary by a factor of ±5% due to various experimental conditions.

In yet another experiment, the proposed approach may be applied to other types of tree-based ensemble models such as CatBoost and Light Gradient-Boosting Machine (LightGBM). In a non-limiting implementation, the experimental results for the same are as follows:

TABLE 7
Experimental results for a proposed approach using other ensemble models

| | CatBoost | | | | LightGBM | | | |
|---|---|---|---|---|---|---|---|---|
| | Calibration | | Model | | Calibration | | Model | |
| | Performance | | Performance | | Performance | | Performance | |
| | | Brier | F1 | | | Brier | F1 | |
| | ECE | score | Score | AUROC | ECE | score | Score | AUROC |
| Without | 0.0320 | 0.0020 | 0.9538 | 0.7898 | 0.0005 | 0.00003 | 0.99930 | 0.94147 |
| Calibration | | | | | | | | |
| Position- | 0.0145 | 0.0075 | 0.9580 | 0.7892 | 0.0001 | 0.00013 | 0.99923 | 0.94901 |
| type leaf- | | | | | | | | |
| based | | | | | | | | |
| encoding | | | | | | | | |
| Weight- | 0.0175 | 0.0041 | 0.9539 | 0.7912 | 0.0001 | 0.00006 | 0.99926 | 0.95301 |
| type leaf- | | | | | | | | |
| based | | | | | | | | |
| encoding | | | | | | | | |
| Platt | 0.0340 | 0.0005 | 0.9538 | 0.7898 | 0.0003 | 0.00001 | 0.99926 | 0.94147 |
| Scaling | | | | | | | | |
| Isotonic | 0.0349 | 0.0008 | 0.9552 | 0.7962 | 0.0005 | 0.00008 | 0.99924 | 0.93347 |
| Regression | | | | | | | | |

From Table 7, it may be observed that the proposed approach with these two tree-based ensemble models improves the calibration performance and the model performance. Based on these observations, it may be understood that the proposed approach is expected to operate not only with the XGBoost algorithm but also with other tree-based models. It is noted that the results shown in Table 7 are approximate in nature and may vary by a factor of ±5% due to various experimental conditions.

Further, in yet another experiment, the application of the regularization is tested on other datasets, such as the credit card dataset, the ECG dataset, and the bankruptcy dataset. In a non-limiting implementation, the experimental results for the same are as follows:

TABLE 8
Experimental results with regularization applied
to the calibration model for different datasets

| | | Credit card | | | | Bankruptcy | |
|---|---|---|---|---|---|---|---|
| | | Dataset | | ECG Dataset | | Dataset | |
| Method | Regularization | F1 | ECE | F1 | ECE | F1 | ECE |
| No | L1 in base model | 0.99935 | 0.0003 | 0.98012 | 0.0034 | 0.96423 | 0.0091 |
| Calibration | L2 in base model | 0.99953 | 0.0004 | 0.98086 | 0.0062 | 0.96247 | 0.0063 |
| Proposed | L1 in base with | 0.99926 | 0.0001 | 0.98781 | 0.0012 | 0.96553 | 0.0044 |
| (weight-type | WLE + L2 in | | | | | | |
| leaf-based | calibration | | | | | | |
| encoding | L2 in base with | 0.99950 | 0.0001 | 0.98091 | 0.0013 | 0.96317 | 0.0056 |
| (WLE)) | WLE + L2 in | | | | | | |
| | calibration | | | | | | |
| Proposed | L1 in base with | 0.99938 | 0.0001 | 0.98734 | 0.0013 | 0.95299 | 0.0147 |
| (position-type | PLE + L2 in | | | | | | |
| leaf-based | calibration | | | | | | |
| encoding | L2 in base with | 0.99943 | 0.0001 | 0.98906 | 0.0015 | 0.95894 | 0.0136 |
| (PLE)) | PLE + L2 in | | | | | | |
| | calibration | | | | | | |

From Table 8, it may be observed that the parameters such as the ECE and F1 score for different combinations of the regularization L1 and L2 with the base model (i.e., the set of decision trees 220) and the calibration model 222 are measured. For instance, the parameters for the different datasets with no calibration on L1 in the base model and L2 in the base model can be observed. In another instance, L1 in the base model with the weight-type leaf-based encoding 542 and L2 in the calibration model 222 (i.e., L1 in base with WLE+L2 in calibration as shown in Table 8) can be observed. Similarly, in other instances, L2 in both the base model and the calibration model 222 with the weight-type leaf-based encoding 542, L1 in the based model, and L2 in the calibration model 222 with the position-type leaf-based encoding 522, and L2 in both the base model and the calibration model 222 with the position-type leaf-based encoding 522 can be observed.

It may also be observed that, while regularization in the base model helps calibration, the proposed approach used with L2 regularization on the calibration model 222, further improves the calibration. In addition, it also improves the model performance on two out of three datasets, such as it improves on the credit card dataset and the ECG dataset. It is noted that the results shown in Table 8 are approximate in nature and may vary by a factor of +5% due to various experimental conditions.

Referring to FIG. 7, it may be observed that the ECE may increase upon application of the regularization. It may also be observed that the model performance is also improved as the parameter C is tuned to a desirable value.

Further, in one experiment, a dimensionality of the tree-based encodings 502, such as the position-type leaf-based encoding 522 and the weight-type leaf-based encoding 542 for different input datasets can be observed. In a non-limiting implementation, the experimental results for the same are as follows:

TABLE 9
Dimensionality of a tree-based encoding for
different input datasets and encoding type

| | Position-type leaf-based | Weight-type leaf-based |
|---|---|---|
| | encoding | encoding |
| Airline dataset | 142916 | 445 |
| Bitcoin dataset | 15698 | 277 |
| Credit card | 1472 | 80 |
| dataset | | |
| Bankruptcy | 486 | 22 |
| dataset | | |

Referring to Table 9, it can be observed that the weight-type leaf-based encoding 542 is much smaller in size than the position-type leaf-based encoding 522 for the different input datasets. As a result, the weight-type leaf-based encoding 542 can be preferred in deployment scenarios for several real-world applications. It is noted that the results shown in Table 9 are approximate in nature and may vary by a factor of +5% due to various experimental conditions.

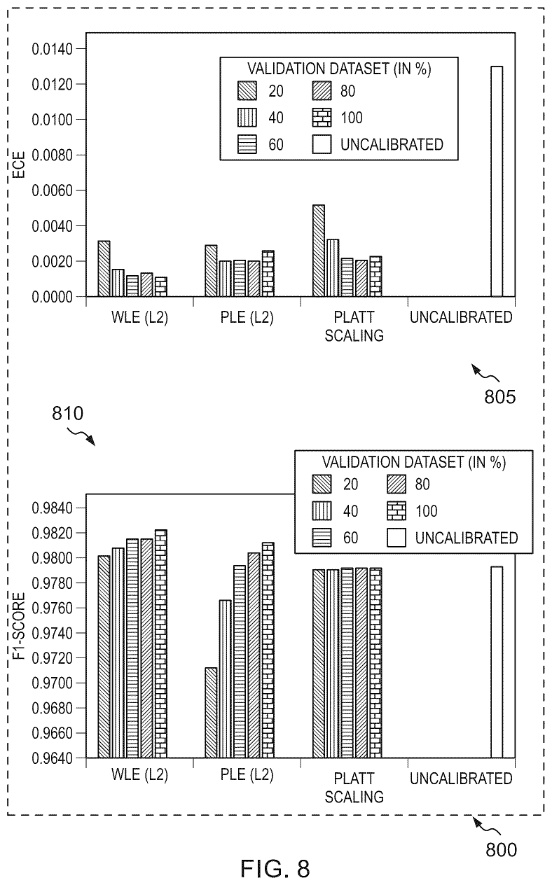

FIG. 8 illustrates a graphical representation 800 depicting an impact on the calibration error such as the ECE (see, 805) and the model performance parameter such as F1 (see, 810), for different calibration processes and different sizes for the validation dataset, in accordance with an embodiment of the present disclosure. As may be understood, the different calibration processes can include the calibration model 222 with the position-type leaf-based (PLE) 522, the calibration model 222 with the weight-type leaf-based encoding (WLE) 542, Platt Scaling, and the like. For each process, the input dataset 218 considered can be the ECG dataset.

It may be observed that the validation dataset is increased in terms of percentage (%), such as 20%, 40%, 60%, 80%, and 100%. With the increase in the size of the validation dataset, it may be observed that the position-type leaf-based encoding 522 benefited as the ECE decreased and the F1 score was observed to increase. In other words, it may be observed that the position-type leaf-based encoding 522 is very sparse with the increasing size of the validation dataset. Further, the calibration model 222 is allowed to observe a far greater variation of the encoding inputs and hence might perform better with a larger size of the validation dataset.

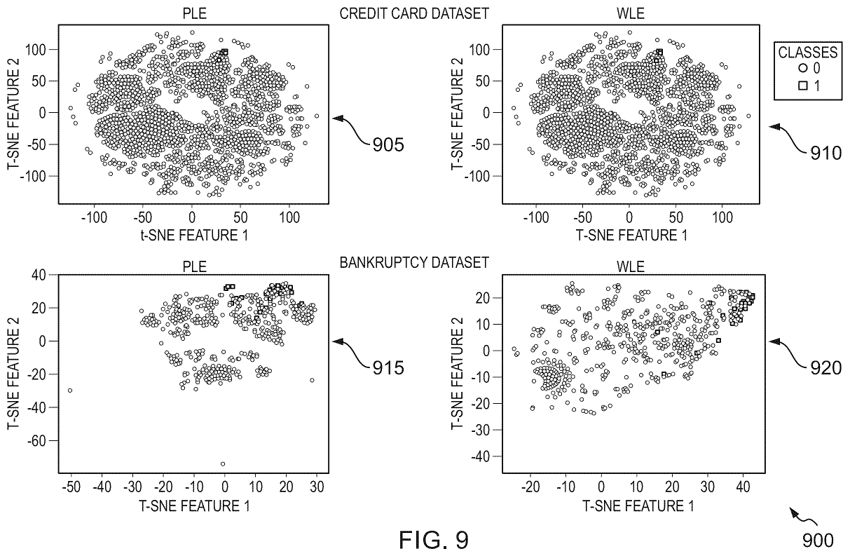

FIG. 9 illustrates a graphical representation 900 for t-distributed stochastic neighbor embedding (T-SNE) plots (see, 905, 910, 915, and 920) for different datasets and encoding types, in accordance with an embodiment of the present disclosure. It may be observed that for the input datasets, such as the credit card dataset and the bankruptcy dataset, two classes (i.e., class 0 and class 1) predicted by the calibration model 222 after calibration, can be observed to be well separable. It may be noted that separability is well observed in the reduced two-dimensional space. As a result, the discriminative power of these embeddings is confirmed from FIG. 9. In other words, it may be observed that the two classes occupy different spaces in the encoding space. It is to be noted that the tree-based encodings 502 may not only be used to train the calibration model 222, but the calibration model 222 in itself is a useful approach to finetune the base ensemble model (i.e., the set of decision trees 220), to an out of time data or a different distribution on training dataset without changing the base ensemble model.

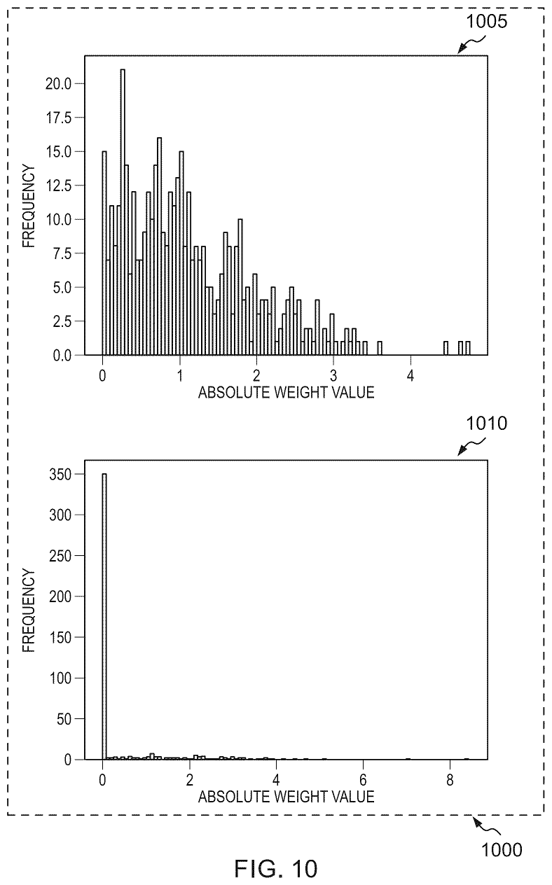

FIG. 10 illustrates a graphical representation 1000 for weight histograms of the calibration model 222 for different experimental setups (see, 1005 and 1010), in accordance with an embodiment of the present disclosure. One of the experimental setups is to train the calibration model 222 on the validation dataset of the airline dataset using the XGBoost model as the base model for best L2 (at C=5) using the weight-type leaf-based encoding 542 (see, 1005 for its corresponding weight histogram). Another experimental setup includes training the calibration model 222 with the same training dataset with the same base model and the encoding type, with L1 regularization (at C=0.8) (see, 1010 for its corresponding weight histogram). Thus, from FIG. 10 it may be observed that L1 regularization results in almost all weights being zero.

In a non-limiting implementation, another experiment may be conducted during the inference stage of the calibration model 222 trained using the calibration process 500 proposed in the present disclosure. It may be observed that, during the inference stage of the calibration model 222, the probability scores for every sample would change during the calibration of the calibration model 222 compared to what was initially available from the base model. The change in bin-wise sample distribution can be analyzed by applying the testing dataset to the uncalibrated model, the models calibrated using the proposed approach, and all the other baselines.

It is to be noted that, to observe the bin-wise sample distribution, the testing dataset can be any of the four input datasets, such as the airline dataset, the bitcoin dataset, the credit card dataset, and the bankruptcy dataset. Further, the predictions on each dataset can be broken down into sample share in each bin, during evaluation on the testing dataset of each input dataset. It may also be noted that the bin-wise sample distribution can give useful observation as to how samples move across bins after calibration by different calibration processes, compared to the model without any calibration. These bins are generated by taking a set of probabilistic outcomes of the testing dataset that fall within a range of values. In a non-limiting example, Bin-6 represents values between 0.5 to 0.6 for the output probability of the model, followed by each higher bin having the same interval range. Further, in a non-limiting implementation, the experimental results for the same can be as follows:

TABLE 10
Bin-wise sample distribution of an airline dataset

| | Airline dataset | | | | | | |
|---|---|---|---|---|---|---|---|
| | Bin- | Bin- | Bin- | Bin- | Bin- | | F1- |
| | 6 | 7 | 8 | 9 | 10 | ECE | Score |
| Without calibration | 624 | 1110 | 769 | 1066 | 22909 | 0.0128 | 0.949 |
| Position-type leaf-based | 889 | 955 | 1108 | 1592 | 21434 | 0.0069 | 0.947 |
| encoding | | | | | | | |
| Weight-type leaf-based | 730 | 743 | 876 | 1236 | 22391 | 0.0041 | 0.950 |
| encoding | | | | | | | |
| Platt Scaling | 0 | 0 | 0 | 0 | 25976 | 0.0510 | 0.949 |
| Isotonic Regression | 1019 | 977 | 519 | 1522 | 21939 | 0.0048 | 0.948 |

TABLE 11
Bin-wise sample distribution of an bitcoin dataset

| | Bitcoin dataset | | | | | | |
|---|---|---|---|---|---|---|---|
| | Bin- | Bin- | Bin- | Bin- | Bin- | | F1- |
| | 6 | 7 | 8 | 9 | 10 | ECE | Score |
| Without calibration | 8 | 11 | 32 | 109 | 9153 | 0.0390 | 0.953 |
| Position-type leaf-based | 249 | 251 | 44 | 204 | 8565 | 0.0310 | 0.942 |
| encoding | | | | | | | |
| Weight-type leaf-based | 19 | 19 | 24 | 93 | 9158 | 0.0105 | 0.961 |
| encoding | | | | | | | |
| Platt Scaling | 0 | 0 | 0 | 0 | 9313 | 0.0390 | 0.953 |
| Isotonic Regression | 3 | 0 | 1 | 39 | 9270 | 0.0372 | 0.954 |

TABLE 12
Bin-wise sample distribution of a credit card dataset

| | Credit card Dataset | | | | | | |
|---|---|---|---|---|---|---|---|
| | Bin- | Bin- | Bin- | Bin- | Bin- | | F1- |
| | 6 | 7 | 8 | 9 | 10 | ECE | Score |
| Without calibration | 4 | 3 | 3 | 25 | 42687 | 0.0092 | 0.999 |
| Position-type leaf-based | 7 | 7 | 16 | 18 | 42674 | 0.0001 | 0.999 |
| encoding | | | | | | | |
| Weight-type leaf-based | 5 | 4 | 2 | 17 | 42694 | 0.0001 | 0.999 |
| encoding | | | | | | | |
| Platt Scaling | 0 | 0 | 0 | 0 | 42722 | 0.0006 | 0.999 |
| Isotonic Regression | 17 | 12 | 0 | 0 | 42691 | 0.0003 | 0.999 |

TABLE 13
Bin-wise sample distribution of a bankruptcy dataset

| | Bankruptcy Dataset | | | | | | |
|---|---|---|---|---|---|---|---|
| | Bin- | Bin- | Bin- | Bin- | Bin- | | F1- |
| | 6 | 7 | 8 | 9 | 10 | ECE | Score |
| Without calibration | 9 | 11 | 20 | 53 | 930 | 0.0403 | 0.957 |
| Position-type leaf-based | 19 | 19 | 23 | 21 | 941 | 0.0078 | 0.958 |
| encoding | | | | | | | |
| Weight-type leaf-based | 9 | 23 | 24 | 33 | 934 | 0.0097 | 0.961 |
| encoding | | | | | | | |
| Platt Scaling | 0 | 0 | 0 | 0 | 1023 | 0.0323 | 0.984 |
| Isotonic Regression | 5 | 60 | 0 | 38 | 918 | 0.0067 | 0.969 |

It is noted that the results shown in Table 10 to Table 13 are approximate in nature and may vary by a factor of ±5% due to various experimental conditions. From Table 10 to Table 13, the following observations can be made across all four testing datasets:
1. It may be observed that the proposed approach using the weight-type leaf-based encoding 542 maintains the sample-wise distribution close to the original distribution (that of an uncalibrated model). The improvement in ECE can be attributed to the inherent assumption that the migration of samples across bins is in the right manner.
2. Another observation can be that the maximum disruption in bin-wise sample distribution is caused by Platt Scaling. It shifts nearly all samples to the highest bin (Bin-10).

Thus, it may be understood that the proposed approach is intended to calibrate an ensemble of tree models (i.e., the set of decision trees 220) trained on a dataset using a holdout validation dataset, which not only improves calibration performance but also provides superior model performance on standard accuracy metrics. The proposed approach relies on an encoding technique that generates an intermediate representation (i.e., the tree-based encoding) of the input, which is subsequently used by the calibration model 222 which is regularized and is to be trained on the validation dataset. The final model is a combination of the previously trained ensemble which feeds in the tree-based encodings 502 into the calibration model 222 which generates the final probability scores for every testing sample. Upon conducting multiple experiments and visualizations, it may be observed that the proposed approach improves calibration and does not hurt model performance.

FIG. 11 illustrates a schematic representation of another environment 1100 related to at least some example embodiments of the present disclosure. Although the environment 1100 is presented in one arrangement, other embodiments may include the parts of the environment 1100 (or other parts) arranged otherwise depending on, operations performed similar to that performed in the environment 100. Thus, it should be noted that the environment 1100 is an example implementation of the environment 100, with the environment 1100 representing a financial industry in which the users 104 can be at least one of cardholders and merchants. Thus, the data samples of the environment 100 may correspond to payment transactions performed between the cardholders and the merchants in the environment 1100. Also, the data sources 106 of the environment 100 can be at least one of the issuer servers, the acquirer servers, the payment servers, and the like.

In one embodiment, the environment 1100 includes entities, such as the server system 1102, a plurality of cardholders 1104(1), 1104(2), . . . 1104(N) (collectively referred to hereinafter as a ‘plurality of cardholders 1104’ or simply ‘cardholders 1104’), a plurality of merchants 1106(1), 1106(2), . . . 1106(N) (collectively referred to hereinafter as a ‘plurality of merchants 1106’ or simply ‘merchants 1106’), a plurality of issuer servers 1108(1), 1108(2), . . . 1108(N) (collectively referred to hereinafter as a ‘plurality of issuer servers 1108’ or simply ‘issuer servers 1108’), a plurality of acquirer servers 1110(1), 1110(2), . . . 1110(N) (collectively referred to hereinafter as a ‘plurality of acquirer servers 1110’ or simply ‘acquirer servers 1110’), a payment network 1112 including a payment server 1114, and a database 1116 each coupled to, and in communication with (and/or with access to) the network 110. Herein, it may be noted that ‘N’ is a non-zero natural number that may be different for each entity. In a non-limiting implementation, the server system 1102 is a payment server (e.g., the payment server 1114) associated with a payment network (e.g., the payment network 1112).

As used herein, the term “cardholder” refers to a person who has a payment account or a payment card (e.g., credit card, debit card, etc.,) associated with the payment account, that will be used by a merchant to perform a payment transaction. The payment account may be opened via an issuing bank or an issuer server (e.g., the issuer server 1108(1)). Similarly, as used herein, the term “merchant” refers to a seller, a retailer, a purchase location, an organization, or any other entity that is in the business of selling goods or providing services, and it can refer to either a single business location or a chain of business locations of the same entity. Further, as used herein, the term “payment network” refers to a network or collection of systems used for the transfer of funds through the use of cash substitutes. Payment networks are companies that connect an issuing bank with an acquiring bank to facilitate online payment. In an example, the cardholders 1104 may use their corresponding electronic devices to access a mobile application or a website associated with the issuing bank, or any third-party payment application to perform a payment transaction.

Due to the complexity of the banking network, in some embodiments, the cardholder 1104(1) and the merchant 1106(1) can be associated with the same banking institution, e.g., ABC Bank. In such a situation, the ABC Bank will act as an issuer for the cardholder 1104(1) and an acquirer for the merchant 1106(1). Thus, a banking institution may act as both an acquirer and/or an issuer depending on the needs of its clients.

In one embodiment, the payment network 1112 may be used by the payment card issuing authorities such as the issuers, as a payment interchange network. A payment interchange network allows for the exchange of electronic payment transaction data between the issuers and the acquirers. The payment network 1112 includes the payment server 1114 which is responsible for facilitating the various operations of the payment network 1112. In one scenario, the payment server 1114 is configured to operate a payment gateway for facilitating the various entities in the payment network 1112 to perform digital transactions.

As may be understood, an ML model that is specifically trained for fraud detection, if generates a 60% probability of fraud for several transactions such as 100 transactions, and if the ML model assigns this confidence, then 60 out 100 transactions that are assigned with this probability score should actually prove to be fraudulent. Generally, in binary classification, a threshold of 0.5 is set for fraud detection models to classify whether the transaction is fraudulent or not. If the probability score for a particular transaction is greater than or equal to 0.5, then the transaction is classified to be fraudulent, else non-fraudulent. However, this score can also indicate the confidence with which the ML model has classified them. Thus, the transactions that have probabilities close to the threshold have less confidence, and hence there is a possibility that they are wrongly classified by the ML model. In other words, if the number of fraud transactions is lower than the probability scores, then the ML model is more confident than it should have been. Also, if the probability score does not represent the true probability of the event of fraud detection, setting a threshold becomes difficult. Further, even if a threshold is assigned to capture a specific performance, it is very difficult to predict whether a 0.9 score represents a riskier transaction than a 0.7 score. In such a scenario, if the score is greater than the threshold, even if it is close to the threshold, the transaction will be declined by the payment network, even if the transaction in reality is not fraudulent. As a result, calibration of such probability scores is important. Moreover, if a dataset that is used for training the ML model is imbalanced, if high accuracy results are expected with high speed and better efficiency, then a tree-based model such as the XGBoost model would be a preferred ML model for fraud detection. However, as may be understood, the conventional approaches are applicable for NN-based models and not for tree-based models.

As a result, the server system 1102 proposed in the present disclosure may be used to generate a calibrated prediction for an event such as the fraud detection. It is to be noted that the event can be any event in the financial industry, without limiting the scope of the approach proposed in the present disclosure. In one embodiment, the server system 1102 may facilitate payment processors to facilitate the ML model to generate the calibrated prediction for the event. Further, it may be noted that, in a specific example, the server system 1102 coupled with the database 1116 is embodied within a payment server (e.g., the payment server 1114) associated with the payment processor, however, in other examples, the server system 1102 can be a standalone component (acting as a hub) connected to the issuer servers 1108 and the acquirer servers 1110.

In one embodiment, the ML model can include a set of decision trees 1118 that is pre-trained to generate an intermediate prediction related to the fraud detection event. Herein, the intermediate prediction is poorly calibrated. To calibrate this prediction using a post-processing approach, a new model such as a calibration model 1120 is introduced in the present disclosure. The prediction generated by the calibration model 1120 is considered to be a calibrated prediction.

In a non-limiting implementation, an input dataset 1122 may be considered and split into a training dataset, a validation dataset, and a testing dataset with different timelines. It is to be noted that, if the set of decision trees 1118 is trained on the input dataset 1122 including the training dataset, then the calibration model 1120 is trained on the input dataset 1122 including the validation dataset, and then tested based on the input dataset 1122 including the testing dataset. As both the models are trained for the same event, training them on different datasets ensures that fair predictions are generated by each model.

In a specific implementation, the input dataset 1122 may include a cardholder-related dataset. Along with the cardholder-related dataset, the database 1116 may also store a merchant-related dataset and any other historical information that may be related to a plurality of payment transactions performed between the cardholders 1104 and the merchants 1106 in a payment ecosystem. For example, the historical information may include, but is not limited to, transaction attributes, such as transaction amount, source of funds such as bank accounts, debit cards or credit cards, transaction channel used for loading funds such as Point of Sale (POS) terminal or Automated Teller Machine (ATM), transaction velocity features such as count and transaction amount sent in the past ‘x’ number of days to a particular user, external data sources, merchant country, merchant Identifier (ID), cardholder Identifier (ID), cardholder product, cardholder Permanent Account Number (PAN), Merchant Category Code (MCC), merchant location data or merchant co-ordinates, merchant industry, merchant super industry, ticket price, and other transaction-related data.

In other various examples, the database 1116 may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data.

By accessing the input dataset 1122, the server system 1102 is configured to obtain a feature set for training the set of decision trees 1118 to generate the intermediate prediction and the calibration model 1120 to generate the prediction that is calibrated. In order to do so, the server system 1102 may perform various operations. It should be noted that these operations are already explained above with reference to FIG. 1 to FIGS. 5A-5C and several experiments have also been conducted. To that note, these operations are not described again for the sake of brevity. However, in brief, when a payment transaction is initiated between a cardholder (e.g., the cardholder 1104(1)) and a merchant (e.g., the merchant 1106(1)), the server system 1102 may be configured to receive a prediction request for the corresponding payment transaction between the cardholder 1104(1) and the merchant 1106(1). Suppose the prediction request corresponds to a fraud detection request.

The server system 1102 may be further configured to generate an intermediate prediction for the payment transaction based, at least in part, on applying the feature set of each payment transaction from the input dataset 1122 on the set of decision trees 1118. Further, the server system 1102 may be configured to identify an activated leaf node from each decision tree based, at least in part, on the intermediate prediction. In one embodiment, the activated leaf node may indicate a leaf node of one or more leaf nodes of the corresponding decision tree contributing to the intermediate prediction. The server system 1102 may be further configured to generate a tree-based encoding indicating an encoded representation of the set of decision trees 1118 for each payment transaction based, at least in part, on an encoding type and the activated leaf node from each decision tree. Lastly, the server system 1102 may generate the prediction for the payment transaction being fraudulent or not based, at least in part, on the tree-based encoding for each payment transaction. In one embodiment, the server system 1102 generates the prediction using the calibration model 1120. Moreover, the prediction is calibrated based on the tree-based encoding.

FIG. 12 illustrates a schematic representation of yet another environment 1200 related to at least some example embodiments of the present disclosure. Although the environment 1200 is presented in one arrangement, other embodiments may include the parts of the environment 1200 (or other parts) arranged otherwise depending on, operations performed similar to that performed in the environment 100. Thus, it should be noted that the environment 1200 is an example implementation of the environment 100, with the environment 1200 representing a weather forecasting application in which the users 104 can be at least one of the individuals that provide relevant information for weather forecasting while requesting a weather forecast of a particular location. Similarly, the data sources 106 can be satellites, data gathering stations, sensors, and the like that can gather the relevant information for weather forecasting. Thus, the data samples of the environment 100 may correspond to records of weather conditions at a specific time and location in the environment 1200. For example, the data samples can be hourly or daily observations.

In one embodiment, the environment 1200 includes entities, such as the server system 1202, a plurality of users 1204(1), 1204(2), . . . 1204(N) (collectively referred to hereinafter as a ‘plurality of users 1204’ or simply ‘users 1204’), a plurality of weather forecasting agencies 1206(1), 1206(2), . . . 1206(N) (collectively referred to hereinafter as a ‘plurality of weather forecasting agencies 1206’ or simply ‘weather forecasting agencies 1206’), a plurality of weather data sources 1208(1), 1208(2), . . . 1208(N) (collectively referred to hereinafter as a ‘plurality of weather data sources 1208’ or simply ‘weather data sources 1208’), and the database 1210 each coupled to, and in communication with (and/or with access to) the network 110. Herein, it may be noted that ‘N’ is a non-zero natural number that may be different for each entity.

As used herein, the term “user” refers to a person who is willing to receive predictions related to a weather condition at a particular location during a particular time duration. It is to be noted that as the users 1204 request for a weather forecast, they can also provide the information such as location, date and time, preferences, alerts, activities, and the like to the weather forecasting application. This application is designed to generate predictions related to weather conditions. It is to be noted that, the information provided by the users 1204 influences how the weather forecast is generated by the server system 1202. In an instance, the users 1204 can be individuals, institutions, organizations, etc., that are willing to know or predict weather conditions at certain locations and certain time durations.

Similarly, as used herein, the term “weather forecasting agency” refers to an organization that monitors, analyzes, and predicts weather conditions using data from satellites, radars, weather stations, and computer models. These agencies provide forecasts, warnings, and climate information to help the public, businesses, and governments prepare for weather-related events. It is to be noted that the weather forecasting agencies 1206 can receive input not only from the users 1204 but also from the weather data sources 1208. Various examples for the weather data sources 1208 can include weather stations, sensors, radiosondes, aircraft and ships, radar, etc.

In an example, the weather forecasting agencies 1206 may provide a mobile application (such as the weather forecasting application) or a website for receiving requests from the users 1204 asking for weather forecasts of specific locations. These requests are generally associated with the relevant information that influences the weather forecast that the application will provide. For example, whether it will be a sunny day or a rainy day on a particular day based on the location of the user 1204(1). These websites also play a major role in capturing and storing weather-related data from the weather data sources 1208 that may be associated with individual weather forecasting agencies 1206. The users 1204 may use their corresponding electronic devices to access the mobile application or the website associated with the weather forecasting agencies 1206 to request predictions related to different weather conditions, details related to the predictions, predictions in certain formats, etc.

As may be understood, one or more AI or ML models that are specifically trained for predicting results for weather forecast-related tasks are poorly calibrated. For example, a model can generate a prediction that it will rain on a specific day or not with a predicted probability of 0.6. The model may generate the probability of 0.6 for 10 consecutive days. Now, if the model has confidence that at least 60% of its predictions are correct, then for at least 6 days of the 10 days, there will be a 60% chance (due to the predicted probability of 0.6) that it will rain. As may be noted, there may be at max 4 days where the predicted probability by the model may be incorrect. Since, the overall probability, i.e., 60% is close to a 50% chance of there not being any rain, therefore the likelihood of the prediction being incorrect is high. If the prediction made based on these predicted probabilities has a high chance of being incorrect, then people relying on these predictions may unnecessarily carry an umbrella with them. As a result, trust in such an application may be lost and it will be difficult for people to decide whether to carry an umbrella or not while going outdoors.

To address this issue, the server system 1202 proposed in the present disclosure may be used to generate a calibrated prediction for an event such as the weather forecasting event. In one embodiment, the server system 1202 may facilitate the weather forecasting agencies 1206 to facilitate the ML model to generate the calibrated prediction for the event. Further, it may be noted that, in a specific example, the server system 1202 coupled with the database 1210 is embodied within a weather data source (e.g., the weather data source 1208(1)), however, in other examples, the server system 1202 can be a standalone component (acting as a hub) connected to the weather data sources 1208.

In one embodiment, the ML model can include a set of decision trees 1212 that is pre-trained to generate an intermediate prediction related to the weather forecasting event. Herein, the intermediate prediction is poorly calibrated. To calibrate this prediction using a post-processing approach, a new model such as a calibration model 1214 is introduced in the present disclosure. The prediction generated by the calibration model 1214 is considered to be a calibrated prediction.

In a non-limiting implementation, an input dataset 1216 may be considered and split into a training dataset, a validation dataset, and a testing dataset with different timelines. It is to be noted that, if the set of decision trees 1212 is trained on the input dataset 1216 including the training dataset, then the calibration model 1214 is trained on the input dataset 1216 including the validation dataset, and then tested based on the input dataset 1216 including the testing dataset. As both the models are trained for the same event, training them on different datasets ensures that fair predictions are generated by each model.

In a specific implementation, the input dataset 1216 may include a weather-related dataset. Along with the weather-related dataset, the database 1210 may also store user inputs, weather forecasting agency information, and any other historical information that may be related to individual weather records. In an example, the historical information may include, but is not limited to, temperature, humidity, wind speed, wind direction, atmospheric moisture, precipitation, storm movement, and the like.

By accessing the input dataset 1216, the server system 1202 is configured to obtain a feature set for training the set of decision trees 1212 to generate the intermediate prediction and the calibration model 1214 to generate the prediction that is calibrated. In order to do so, the server system 1202 may perform various operations. It should be noted that these operations are already explained above with reference to FIG. 1 to FIGS. 5A-5C and several experiments have also been conducted. To that note, these operations are not described again for the sake of brevity.

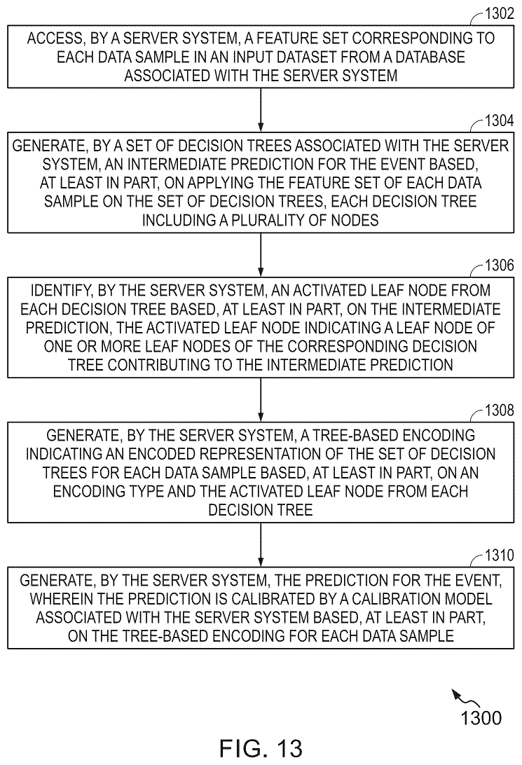

FIG. 13 illustrates a flow diagram depicting a method 1300 for generating a prediction for an event, in accordance with an embodiment of the present disclosure. The method 1300 depicted in the flow diagram may be executed by, for example, the server system 200. The sequence of operations of the method 1300 may not be necessarily executed in the same order as they are presented. Further, one or more operations may be grouped and performed in the form of a single step, or one operation may have several sub-steps that may be performed in parallel or in a sequential manner. Operations of the method 1300, and combinations of operations in the method 1300 may be implemented by, for example, hardware, firmware, a processor, circuitry, and/or a different device associated with the execution of software that includes one or more computer program instructions. The plurality of operations is depicted in the process flow of the method 1300. The process flow starts at operation 1302.

At operation 1302, the method 1300 includes accessing, by a server system (e.g., the server system 200), a feature set corresponding to each data sample in an input dataset (e.g., the input dataset 218) from a database (e.g., the database 204) associated with the server system 200.

At operation 1304, the method 1300 includes generating, by a set of decision trees (e.g., the set of decision trees 220) associated with server system 200, an intermediate prediction for the event based, at least in part, on applying the feature set of each data sample on the set of decision trees 220. Herein, each decision tree may include a plurality of nodes.

At operation 1306, the method 1300 includes identifying, by the server system 200, an activated leaf node from each decision tree based, at least in part, on the intermediate prediction. Herein, the activated leaf node may indicate a leaf node of one or more leaf nodes of the corresponding decision tree contributing to the intermediate prediction.

At operation 1308, the method 1300 includes generating, by the server system 200, a tree-based encoding indicating an encoded representation of the set of decision trees 220 for each data sample based, at least in part, on an encoding type and the activated leaf node from each decision tree.

At operation 1310, the method 1300 includes generating, by the server system 200, the prediction for the event. The prediction is calibrated by a calibration model (e.g., the calibration model 222) associated with the server system 200 based, at least in part, on the tree-based encoding for each data sample.

The disclosed method 1300 with reference to FIG. 13, or one or more operations of the server system 200 may be implemented using software including computer-executable instructions stored on one or more computer-readable media (e.g., non-transitory computer-readable media, such as one or more optical media discs, volatile memory components (e.g., Dynamic Random Access Memory (DRAM) or Statis Random Access Memory (SRAM)), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication mode. Such a suitable communication modes include, for example, the Internet, the World Wide Web, an intranet, software applications, cable (including fiber optic cable), magnetic communications, electromagnetic communications (including RF, microwave, and infrared communications), electronic communications, or other such communication modes.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which, are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for generating a prediction for an event, comprising:
accessing, by a server system, a feature set corresponding to each data sample in an input dataset from a database associated with the server system;
generating, by a set of decision trees associated with the server system, an intermediate prediction for the event based, at least in part, on applying the feature set of each data sample on the set of decision trees, each decision tree comprising a plurality of nodes;
identifying, by the server system, an activated leaf node from each decision tree based, at least in part, on the intermediate prediction, the activated leaf node indicating a leaf node of one or more leaf nodes of the corresponding decision tree contributing to the intermediate prediction;
generating, by the server system, a tree-based encoding indicating an encoded representation of the set of decision trees for each data sample based, at least in part, on an encoding type and the activated leaf node from each decision tree; and
generating, by the server system, the prediction for the event, wherein the prediction is calibrated by a calibration model associated with the server system based, at least in part, on the tree-based encoding for each data sample.

2. The computer-implemented method as claimed in claim 1, wherein generating the tree-based encoding for each data sample comprises:
generating, by the server system, a set of leaf-based encodings for the set of decision trees based, at least in part, on the encoding type and the one or more leaf nodes in each decision tree, each leaf-based encoding indicating a leaf-level encoded representation of each decision tree for each data sample; and
concatenating, the server system, the set of leaf-based encodings to obtain the tree-based encoding for each data sample.

3. The computer-implemented method as claimed in claim 2, wherein generating a leaf-based encoding for a decision tree comprises:
in response to determining that the encoding type is a position-based encoding, generating, by the server system, a position-type leaf-based encoding for the decision tree, wherein the position-type leaf-based encoding is the leaf-based encoding.

4. The computer-implemented method as claimed in claim 3, wherein generating the position-type leaf-based encoding comprises:
assigning, by the server system, a first label to the activated leaf node and a second label to each of remaining leaf nodes of the one or more leaf nodes of the decision tree; and
concatenating, by the server system, the first label and the second label of each of the remaining leaf nodes based, at least on a position of each of the one or more leaf nodes in the decision tree to obtain the position-type leaf-based encoding of the decision tree.

5. The computer-implemented method as claimed in claim 2, wherein generating a leaf-based encoding for a decision tree comprises:
in response to determining that the encoding type is a weight-based encoding, generating, by the server system, a weight-type leaf-based encoding for the decision tree, wherein the weight-type leaf-based encoding is the leaf-based encoding.

6. The computer-implemented method as claimed in claim 5, wherein generating the weight-type leaf-based encoding comprises:
extracting, by the server system, a weight parameter associated with the activated leaf node from the decision tree; and
assigning, by the server system, the extracted weight parameter to the leaf-based encoding of the decision tree to obtain the weight type leaf-based encoding.

7. The computer-implemented method as claimed in claim 1, further comprising:
extracting, by the server system, an intermediate predicted probability score associated with the intermediate prediction for each data sample from the set of decision trees, the intermediate predicted probability score indicating a likelihood of the event to take place;
extracting, by the server system, a predicted probability score associated with the prediction for each data sample from the calibration model, the predicted probability score indicating a calibrated likelihood of the event to take place;
accessing, by the server system, one or more actual behavior parameters related to the event from the database;
computing, by the server system, a first calibration error for each data sample based, at least in part, on the intermediate predicted probability score for each data sample and the one or more actual behavior parameters; and
computing, by the server system, a second calibration error for each data sample based, at least in part, on the predicted probability score for each data sample and the one or more actual behavior parameters.

8. The computer-implemented method as claimed in claim 7, further comprising:
computing, by the server system, an improvisation factor for each data sample based, at least in part, on the first calibration error and the second calibration error, the improvisation factor indicating an extent of a positive impact on calibration of the intermediate prediction.

9. The computer-implemented method as claimed in claim 1, further comprising:
accessing, by the server system, a training feature set for each training data sample of a training dataset from the database, the training feature set comprising ground truth labels;
generating, by the server system, a plurality of training tree-based encodings for a plurality of training data samples, respectively of the training dataset; and
training, by the server system, the calibration model to generate the prediction for the event that is calibrated, wherein training the calibration model comprises performing iteratively until convergence criteria are met, a set of operations comprising:
initializing the calibration model based, at least in part, on one or more calibration model parameters;
generating, by the calibration model, a calibrated predicted probability score for each training data sample based, at least in part, on the plurality of training tree-based encodings and the one or more calibration model parameters, the calibrated predicted probability score indicating a likelihood of an occurrence of the event;
generating, by the calibration model, the prediction for the event based, at least in part, on the calibrated predicted probability score and an event threshold, the prediction comprising a label associated with the event;
computing, by the calibration model, a regularized loss for each training data sample based, at least in part, on the calibrated predicted probability score, the ground truth labels, and a regularized loss function; and
optimizing the one or more calibration model parameters based, at least in part, on the regularized loss.

10. The computer-implemented method as claimed in claim 1, further comprising:
accessing, by the server system, the input dataset from the database, the input dataset comprising the plurality of data samples associated with a plurality of users;
generating, by the server system, the feature set for each data sample of the plurality of data samples based, at least in part, on the input dataset; and
storing, by the server system, the feature set for each data sample in the database.

11. A server system, comprising:
a communication interface;
a memory comprising executable instructions; and
a processor communicably coupled to the communication interface and the memory, the processor configured to cause the server system to at least:
access a feature set corresponding to each data sample in an input dataset from a database associated with the server system;
generate, by a set of decision trees associated with server system, an intermediate prediction for the event based, at least in part, on applying the feature set of each data sample on the set of decision trees, each decision tree comprising a plurality of nodes;
identify an activated leaf node from each decision tree based, at least in part, on the intermediate prediction, the activated leaf node indicating a leaf node of one or more leaf nodes of the corresponding decision tree contributing to the intermediate prediction;
generate a tree-based encoding indicating an encoded representation of the set of decision trees for each data sample based, at least in part, on an encoding type and the activated leaf node from each decision tree; and
generate the prediction for the event, wherein the prediction is calibrated by a calibration model associated with the server system based, at least in part, on the tree-based encoding for each data sample.

12. The server system as claimed in claim 11, wherein to generate the tree-based encoding for each data sample, the server system is further caused, at least in part, to:
generate a set of leaf-based encodings for the set of decision trees based, at least in part, on the encoding type and the one or more leaf nodes in each decision tree, each leaf-based encoding indicating a leaf-level encoded representation of each decision tree for each data sample; and
concatenate the set of leaf-based encodings to obtain the tree-based encoding for each data sample.

13. The server system as claimed in claim 12, wherein to generate a leaf-based encoding for a decision tree, the server system is further caused, at least in part, to in response to determining that the encoding type is a position-based encoding, generate a position-type leaf-based encoding for the decision tree, wherein the position-type leaf-based encoding is the leaf-based encoding.

14. The server system as claimed in claim 13, wherein to generate the position-type leaf-based encoding, the server system is further caused, at least in part, to:
assign a first label to the activated leaf node and a second label to each of remaining leaf nodes of the one or more leaf nodes of the decision tree; and
concatenate the first label and the second label of each of the remaining leaf nodes based, at least on a position of each of the one or more leaf nodes in the decision tree to obtain the position-type leaf-based encoding of the decision tree.

15. The server system as claimed in claim 12, wherein to generate a leaf-based encoding for a decision tree, the server system is further caused, at least in part, to in response to determining that the encoding type is a weight-based encoding, generate a weight-type leaf-based encoding for the decision tree, wherein the weight-type leaf-based encoding is the leaf-based encoding.

16. The server system as claimed in claim 15, wherein to generate the weight-type leaf-based encoding, the server system is further caused, at least in part, to:
extract a weight parameter associated with the activated leaf node from the decision tree; and
assign the extracted weight parameter to the leaf-based encoding of the decision tree to obtain the weight type leaf-based encoding.

17. The server system as claimed in claim 11, wherein the server system is further caused, at least in part, to:
extract an intermediate predicted probability score associated with the intermediate prediction for each data sample from the set of decision trees, the intermediate predicted probability score indicating a likelihood of the event to take place;
extract a predicted probability score associated with the prediction for each data sample from the calibration model, the predicted probability score indicating a calibrated likelihood of the event to take place;
access one or more actual behavior parameters related to the event from the database;
compute a first calibration error for each data sample based, at least in part, on the intermediate predicted probability score for each data sample and the one or more actual behavior parameters; and
compute a second calibration error for each data sample based, at least in part, on the predicted probability score for each data sample and the one or more actual behavior parameters.

18. The server system as claimed in claim 17, wherein the server system is further caused, at least in part, to compute an improvisation factor for each data sample based, at least in part, on the first calibration error and the second calibration error, the improvisation factor indicating an extent of a positive impact on calibration of the intermediate prediction.

19. The server system as claimed in claim 11, wherein the server system is further caused, at least in part, to:
access a training feature set for each training data sample of a training dataset from the database, the training feature set comprising ground truth labels;
generate a plurality of training tree-based encodings for a plurality of training data samples, respectively of the training dataset; and
train the calibration model to generate the prediction for the event that is calibrated, wherein training the calibration model comprises performing iteratively until convergence criteria are met, a set of operations comprising:
initialize the calibration model based, at least in part, on one or more calibration model parameters;
generate, by the calibration model, a calibrated predicted probability score for each training data sample based, at least in part, on the plurality of training tree-based encodings and the one or more calibration model parameters, the calibrated predicted probability score indicating a likelihood of an occurrence of the event;
generate, by the calibration model, the prediction for the event based, at least in part, on the calibrated predicted probability score and an event threshold, the prediction comprising a label associated with the event;
compute, by the calibration model, a regularized loss for each training data sample based, at least in part, on the calibrated predicted probability score, the ground truth labels, and a regularized loss function; and
optimize the one or more calibration model parameters based, at least in part, on the regularized loss.

20. A non-transitory computer-readable storage medium comprising computer-executable instructions that, when executed by at least a processor of a server system, cause the server system to perform a method comprising:
accessing a feature set corresponding to each data sample in an input dataset from a database associated with the server system;
generating, by a set of decision trees associated with server system, an intermediate prediction for the event based, at least in part, on applying the feature set of each data sample on the set of decision trees, each decision tree comprising a plurality of nodes;
identifying an activated leaf node from each decision tree based, at least in part, on the intermediate prediction, the activated leaf node indicating a leaf node of one or more leaf nodes of the corresponding decision tree contributing to the intermediate prediction;
generating a tree-based encoding indicating an encoded representation of the set of decision trees for each data sample based, at least in part, on an encoding type and the activated leaf node from each decision tree; and
generating, by the server system, the prediction for the event, wherein the prediction is calibrated by a calibration model associated with the server system based, at least in part, on the tree-based encoding for each data sample.
